(19) United States
(12) Patent Application Publication
(10) Pub. No.: US 2025/0314982 A1
(43) Pub. Date: Oct. 9, 2025

(54) TONER, CARTRIDGE, AND IMAGE FORMING APPARATUS

(71) Applicant: CANON KABUSHIKI KAISHA, Tokyo (JP)

(72) Inventors: TATSUYA SAEKI, Shizuoka (JP); YUHEI TERUI, Shizuoka (JP); MEGUMI YAMAUCHI, Shizuoka (JP)

(21) Appl. No.: 19/095,478

(22) Filed: Mar. 31, 2025

(30) Foreign Application Priority Data
Apr. 4, 2024 (JP) 2024-060535
Feb. 26, 2025 (JP) 2025-028485

(51) Int. Cl. G03G 9/08; G03G 9/087

(52) U.S. Cl. CPC G03G 9/0827; G03G 9/0819; G03G 9/08755; G03G 2215/0604; G03G 2215/066

(57) ABSTRACT

A toner comprising: a toner particle comprising a binder resin and an ester wax; and an external additive, wherein the binder resin comprises a polyester resin comprising a dodecenylsuccinic acid unit, a molecular weight of the ester wax is at least 650, the external additive comprises a needle-shaped inorganic particle, a number-average value of minor diameter of the needle-shaped inorganic particle is at least 10 nm, a number-average value of aspect ratio of the needle-shaped inorganic particle is at least 5, and X and Y satisfy the following Formula (1), where X (mass %) is a content of the dodecenylsuccinic acid unit based on a mass of the toner particle and Y (mass %) is a content of the ester wax based on the mass of the toner particle,

$$0.25 \leq Y / X \leq 4.0 0. \qquad ( 1 )$$

### BACKGROUND OF THE INVENTION

### Field of the Invention

The present disclosure relates to a toner, a cartridge, and an image forming apparatus for developing an electrostatic image used in an image forming apparatus such as electrophotographic and electrostatic printing.

### Description of the Related Art

In recent years, there has been a wide demand for a lower energy and a higher process speed of an electrophotographic image forming apparatus (hereinafter, simply referred to as “image forming apparatus”). From the viewpoint of the low energy, it is essential to lower a temperature of a fixing unit of an electrophotographic image forming apparatus, and a so-called “low-temperature fixability” technique for fixing a toner at a low temperature is important. In addition, in an electrophotographic image forming apparatus with a higher speed, the time required for each step such as charging, developing, transferring, or fixing in an electrophotographic process is shortened. Therefore, a “releasability” technique that allows a toner to be instantly released from the fixing unit after being melted is important.

Japanese Patent No. 2007-241091 suggests a technique of adding a polyfunctional ester wax to an amorphous styrene acrylic resin.

Japanese Patent Application Publication No. 2021-001975 suggests a technique of adding an ester wax to an amorphous polyester resin.

Japanese Patent Application Publication No. 2023-057025 and Japanese Patent Application Publication No. 2017-068006 suggest that a plasticizer and a release agent can be added to a toner.

### SUMMARY OF THE INVENTION

According to the studies by the present inventors, it has been found in Japanese Patent Application Publication No. 2007-241091 and Japanese Patent Application Publication No. 2021-001975, the ester wax was not much compatible with a binder resin, and therefore, plasticization of the binder resin was insufficient, resulting in insufficient low-temperature fixability in even an image forming apparatus with a higher speed.

In addition, according to the studies by the present inventors, in Japanese Patent Application Publication No. 2023-057025 and Japanese Patent Application Publication No. 2017-068006, low-temperature fixability was improved because the binder resin is plasticized by low-molecular weight hydrocarbon wax or crystalline polyester. In addition, the effect of the release agent exhibited the effect of the releasability. However, there is a problem that, in an image forming apparatus with a higher speed, a toner cannot be instantly solidified after melting, and the melted toner causes adhesion between sheets of paper to each other after the paper is ejected. This is estimated because a crystallization rate is slow due to domains formed by the plasticizer in the binder resin after melting.

The present disclosure is directed to a toner that has excellent low-temperature fixability and releasability and can suppress adhesion of ejected paper in an image forming apparatus with a higher speed.

The present disclosure relates to a toner comprising:
a toner particle comprising a binder resin and an ester wax; and
an external additive,
wherein the binder resin comprises a polyester resin comprising a dodecenylsuccinic acid unit,
a molecular weight of the ester wax is at least 650,
the external additive comprises a needle-shaped inorganic particle,
a number-average value of minor diameter of the needle-shaped inorganic particle is at least 10 nm,
a number-average value of aspect ratio of the needle-shaped inorganic particle is at least 5, and
X and Y satisfy the following Formula (1), where X (mass %) is a content of the dodecenylsuccinic acid unit based on a mass of the toner particle and Y (mass %) is a content of the ester wax based on the mass of the toner particle,

$$0.25 \leq Y / X \leq 4.0 0. \qquad ( 1 )$$

The present disclosure relates to a cartridge attachable to and detachable from an image forming apparatus,
the cartridge comprising:
   a toner; and
   a toner container that contains the toner,
wherein the toner comprises
   a toner particle comprising a binder resin and an ester wax and
   an external additive,
the binder resin comprises a polyester resin comprising a dodecenylsuccinic acid unit,
a molecular weight of the ester wax is at least 650,
the external additive comprises a needle-shaped inorganic particle,
a number-average value of minor diameter of the needle-shaped inorganic particle is at least 10 nm,
a number-average value of aspect ratio of the needle-shaped inorganic particle is at least 5, and
X and Y satisfy the following Formula (1), where X (mass %) is a content of the dodecenylsuccinic acid unit based on a mass of the toner particle and Y (mass %) is a content of the ester wax based on the mass of the toner particle,

$$0.25 \leq Y / X \leq 4.0 0. \qquad ( 1 )$$

The present disclosure relates to an image forming apparatus comprising:
a toner;
an electrostatic latent image bearing member;
a charging member that charges the electrostatic latent image bearing member;
an exposing unit that forms an electrostatic latent image by exposing the charged electrostatic latent image bearing member; and
a developing unit that develops the electrostatic latent image formed on the electrostatic latent image bearing member using the toner carried on a toner carrying member,
wherein the toner comprises
a toner particle comprising a binder resin and an ester wax and
an external additive,
the binder resin comprises a polyester resin comprising a dodecenylsuccinic acid unit,
a molecular weight of the ester wax is at least 650,
the external additive comprises a needle-shaped inorganic particle,
a number-average value of minor diameter of the needle-shaped inorganic particle is at least 10 nm,
a number-average value of aspect ratio of the needle-shaped inorganic particle is at least 5, and
X and Y satisfy the following Formula (1), where X (mass %) is a content of the dodecenylsuccinic acid unit based on a mass of the toner particle and Y (mass %) is a content of the ester wax based on the mass of the toner particle,

$$0.25 \leq Y / X \leq 4.0 0. \qquad ( 1 )$$

The present disclosure can provide a toner that has excellent low-temperature fixability and releasability and can suppress adhesion of ejected paper in an image forming apparatus with a higher speed.

Further features of the present invention will become apparent from the following description of exemplary embodiments with reference to the attached drawings.

### BRIEF DESCRIPTION OF THE DRAWINGS

FIG. 1 is a cross-sectional view of a cartridge; and

FIG. 2 is a cross-sectional view of an image forming apparatus.

### DESCRIPTION OF THE EMBODIMENTS

In the present disclosure, the description of “from XX to YY” or “XX to YY” representing a numerical range means a numerical range including a lower limit and an upper limit, which are endpoints, unless otherwise specified. In a case where numerical ranges are described stepwise, an upper limit and a lower limit of each numerical range can be arbitrarily combined.

In addition, in the present disclosure, the description such as “at least one selected from the group consisting of XX, YY and ZZ” means any of XX, YY, and ZZ, a combination of XX and YY, a combination of XX and ZZ, a combination of YY and ZZ, or a combination of XX, YY, and ZZ.

The present inventors have conducted intensive studies in order to obtain a toner that has excellent low-temperature fixability and releasability and can further suppress adhesion of ejected paper in an image forming apparatus with a higher speed. As a result, the present inventors have found that the above problems can be solved by controlling the amounts of polyester resin containing a dodecenylsuccinic acid unit and ester wax having a molecular weight of at least 650 and using a needle-shaped inorganic particle as an external additive.

Note that the “unit” means a “monomer unit” and refers to a reacted form of a monomer material in a polymer. The dodecenylsuccinic acid unit is a monomer unit corresponding to dodecenylsuccinic acid. The dodecenylsuccinic acid unit in the polyester resin has a structure in which dodecenylsuccinic acid forms an ester bond, and is represented by, for example, the following Formula (D).

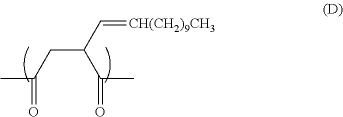

That is, a binder resin in a toner according to the present disclosure is a polyester resin containing a dodecenylsuccinic acid unit, thereby improving compatibility with an ester wax and improving low-temperature fixability. The dodecenylsuccinic acid unit is derived from an alkyl chain and structurally has a low polarity, and therefore has an effect of improving compatibility with a low polarity material such as an ester wax. In particular, the alkyl chain of the dodecenylsuccinic acid is present as a side chain to a polyester molecule, thereby exhibiting higher compatibility with an ester wax.

In addition, when a molecular weight of the ester wax is at least 650, the ester wax can be partially phase-separated from the polyester resin containing the dodecenylsuccinic acid unit. Therefore, the releasability can be improved in a main body with a higher speed.

In addition, in a toner particle, a content X (mass %) of the dodecenylsuccinic acid unit and a content Y (mass %) of the ester wax having a molecular weight of at least 650 are controlled within a range specified by Formula (1). Furthermore, needle-shaped inorganic particles having a number-average value of minor diameters of at least 10 nm and a number-average value of aspect ratios of at least 5 are used as the external additive. It is found that this results in preferred adhesion of ejected paper in a main body with a higher speed.

$$0.25 \leq Y / X \leq 4 \text{.000} \qquad ( 1 )$$

The present inventors have estimated that, by using a specific needle-shaped inorganic particle and satisfying the relationship of Formula (1), a crystallization rate is increased because the ester wax does not form domains after melting in fixing and is dispersed finely in the binder resin. Needle-shaped inorganic particles having a number-average value of minor diameters of at least 10 nm, which is longer than a chain length of the ester wax, and a number-average value of aspect ratios of at least 5, which exhibits a large surface area, are present in the toner after melting. Therefore, it is estimated that the ester wax is dispersed finely around the needle-shaped inorganic particle.

The content X of the dodecenylsuccinic acid unit based on a mass of the toner particles is preferably 2.6 to 20.0 mass %, more preferably 3.0 to 20.0 mass %, and still more preferably 8.0 to 15.0 mass %. Within this range, the adhesion of ejected paper is more likely to be improved. When the content X is at least 2.6 mass %, the adhesion of ejected paper is more likely to be excellent. When the content X is not more than 20.0 mass %, the releasability is more likely to be excellent.

The content P of the dodecenylsuccinic acid unit in the polyester resin is preferably 2.6 to 20.0 mass %, more preferably 3.0 to 17.5 mass %, and still more preferably 4.5 to 15.0 mass %, based on the mass of the polyester resin. Within this range, the adhesion of ejected paper is more likely to be improved. When the content P is at least 2.6 mass %, the adhesion of ejected paper is more likely to be excellent. When the content P is not more than 20.0 mass %, the releasability is more likely to be excellent.

In addition, it is preferable that the polyester resin further contains an isophthalic acid unit. A content of the isophthalic acid unit in the polyester resin is preferably 5.0 to 30.0 mass %, more preferably 7.0 to 25.0 mass %, and still more preferably 10.0 to 20.0 mass %, based on the mass of the polyester resin. Within this range, the adhesion of ejected paper is more likely to be improved. It is considered that this is because the polyester resin is dispersed more finely by the isophthalic acid without domains formed with the ester wax and has a higher crystallization rate.

The content X (mass %) of the dodecenylsuccinic acid unit and the content Y (mass %) of the ester wax based on the mass of the toner particles need to satisfy the following Formula (1). When Y/X is 0.250 to 4.000, a ratio of the ester wax compatible with the polyester resin becomes proper, and therefore, the effect of adhesion of ejected paper is easily obtained.

$$0.25 \leq Y / X \leq 4 \text{.000} \qquad ( 1 )$$

Y/X is preferably 0.350 to 3.000 and more preferably 0.450 to 2.000. Within this range, the adhesion of ejected paper is more likely to be improved.

The content Y of the ester wax based on the mass of the toner particles is preferably 2.0 to 20.0 mass %, more preferably 4.0 to 15.0 mass %, and still more preferably 6.0 to 12.0 mass %. Within this range, compatibility and phase separation of the polyester resin and the ester wax become more appropriate, and the low-temperature fixability and the releasability are more excellent. In addition, since crystallization is accelerated from a state in which the ester wax is compatible with the polyester resin within this range, the adhesion of ejected paper is more excellent.

A molecular weight of the ester wax needs to be at least 650. When the molecular weight is within the above range, the ester wax can be partially phase-separated from the polyester resin. The molecular weight of the ester wax is preferably from 800 to 3,000, more preferably from 1,000 to 2,500, and still more preferably from 1,400 to 2,000. Within this range, the adhesion of ejected paper is further improved in a main body with a higher speed.

Note that, in the present disclosure, the molecular weight of the ester wax is a value obtained by calculating a molecular weight from the structure of the ester wax. In addition, in the case of having a molecular weight distribution such as an ester wax derived from a natural product or a synthetic wax using a monomer derived from a natural product or a polymer as a monomer component, a peak molecular weight of the molecular weight distribution obtained by GPC analysis is defined as the molecular weight of the ester wax.

In addition, an SP value (cal/cm³)^{0.5} of the ester wax is preferably 8.70 to 9.10 and more preferably 8.80 to 9.00. Within this range, the compatibility and phase separation of the ester wax and the polyester resin become more appropriate, and the low-temperature fixability and the releasability are more excellent. In addition, since crystallization is accelerated from a state in which the ester wax is compatible with the polyester resin within this range, the adhesion of ejected paper is more excellent.

In particular, the ester wax is preferably a polyfunctional ester wax represented by the following Formula (2), such as a tetrafunctional ester compound containing four ester bonds in one molecule or a hexafunctional ester compound containing six ester bonds in one molecule. That is, the ester wax preferably contains a compound represented by the following Formula (2).

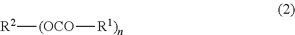

In Formula (2), R¹ represents an alkyl group having 17 to 22 carbon atoms, and n represents the number of (OCO—R¹) bonded to R² and represents an integer of at least 1. R² represents an n-valent hydrocarbon group having 2 to 6 carbon atoms, which may have —O— between C—C bonds.

The ester wax having the structure of Formula (2) has excellent crystallization because the alkyl chain length represented by R¹ is sufficiently long, and contains a sufficient ratio of ester groups to be compatible with the polyester resin. Furthermore, since the chain length of the hydrocarbon group represented by R² is short, strong interaction occurs between the highly polar group portion of the dodecenylsuccinic acid unit and the ester group portion of the wax.

In Formula (2), R¹ is preferably an alkyl group having 17 to 22 carbon atoms and more preferably an alkyl group having 17 to 19 carbon atoms. Within this range, the crystallization of the ester wax becomes faster and the adhesion of ejected paper is further improved.

In Formula (2), R² is preferably an aliphatic hydrocarbon group having 2 to 6 carbon atoms, which may have —O— between C—C bonds, and more preferably an aliphatic hydrocarbon group having 2 to 4 carbon atoms, which may have —O— between C—C bonds. When R² satisfies the above conditions, the chain length of the hydrocarbon group is short, and therefore, strong interaction occurs between the highly polar group portion of the dodecenylsuccinic acid unit and the ester group portion of the wax, and the compatibility and the phase separation property are further improved. R² preferably has one —O— between C—C bonds. Particularly preferably, R² has a structure corresponding to dipentaerythritol and is represented by ≡C₅H₈—O—C₅H₈≡.

In Formula (2), n is preferably 1 to 6 and more preferably 4 to 6. Within this range, the amount of the polyester resin and the amount of the ester group of the ester wax are more preferable, the crystallization of the ester wax after melting becomes faster, and the adhesion of ejected paper is further improved.

The ester wax is preferably at least one selected from the group consisting of a tetrafunctional ester wax, a pentafunctional ester wax, and a hexafunctional ester wax. Examples of the tetrafunctional ester wax include a condensate of pentaerythritol and a monofunctional aliphatic carboxylic acid, and a condensate of diglycerin and a carboxylic acid. Examples of the pentafunctional ester wax include a condensate of triglycerin and a monofunctional aliphatic carboxylic acid. Examples of the hexafunctional ester wax include a condensate of dipentaerythritol and a monofunctional aliphatic carboxylic acid and a condensate of tetraglycerol and a monofunctional aliphatic carboxylic acid.

The aliphatic carboxylic acid is preferably a linear aliphatic carboxylic acid of an alkyl group having 17 to 22 (preferably 17 to 19) carbon atoms and more preferably stearic acid.

It is preferable that the ester wax includes at least one selected from the group consisting of a condensate of pentaerythritol and an aliphatic carboxylic acid and a condensate of dipentaerythritol and an aliphatic carboxylic acid. The ester wax is more preferably at least one selected from the group consisting of a condensate of pentaerythritol and an aliphatic carboxylic acid and a condensate of dipentaerythritol and an aliphatic carboxylic acid.

In addition, it is preferable that the ester wax contains at least one selected from the group consisting of a compound represented by the following Formula (6) and a compound represented by the following Formula (7).

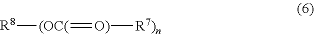

(In Formula (6), R⁷ represents an alkyl group having 15 to 21 carbon atoms, n represents the number of (OC(═O)—R⁷) bonded to R⁸ and represents an integer of at least 2, and R⁸ represents an n-valent hydrocarbon group having 5 to 10 carbon atoms or an n-valent hydrocarbon group having 5 to 10 carbon atoms and having-O-between two carbon atoms.)

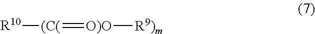

(In Formula (7), R⁹ represents an alkyl group having 15 to 21 carbon atoms, m represents the number of (C(═O)O—R⁹) bonded to R¹⁰ and represents an integer of at least 2, and R¹⁰ represents an m-valent hydrocarbon group having 5 to 10 carbon atoms or an m-valent hydrocarbon group having 5 to 10 carbon atoms and having-O-between two carbon atoms.)

The ester wax having a structure represented by Formula (6) or (7) has excellent crystallization because an alkyl chain length represented by R⁷ or R⁹ is sufficiently long, and a ratio of the ester groups is sufficient to be compatible with the polyester resin. Furthermore, since the chain length of the hydrocarbon group having 5 to 10 carbon atoms represented by R⁸ or R¹⁰ or the hydrocarbon group having-O-between two carbon atoms is short, strong interaction occurs between the highly polar group portion of the dodecenylsuccinic acid unit and the ester group portion of the wax.

In Formula (6), R⁷ is preferably an alkyl group having 15 to 21 carbon atoms and more preferably an alkyl group having 17 to 19 carbon atoms. Within this range, the crystallization of the ester wax becomes faster and the adhesion of ejected paper is further improved.

In Formula (7), R⁹ is preferably an alkyl group having 15 to 21 carbon atoms and more preferably an alkyl group having 17 to 19 carbon atoms. Within this range, the crystallization of the ester wax becomes faster and the adhesion of ejected paper is further improved.

In Formula (6), it is preferable that R⁸ has one —O— between two carbon atoms. In addition, in Formula (6), n is preferably an integer of 2 to 6 and more preferably an integer of 4 to 6. Within this range, the amount of the polyester resin and the amount of the ester group of the ester wax are more preferable, the crystallization of the ester wax after melting becomes faster, and the adhesion of ejected paper is further improved.

In Formula (7), it is preferable that R¹⁰ has one —O— between two carbon atoms. In addition, in Formula (7), m is preferably 2 to 6 and more preferably 4 to 6. Within this range, the amount of the polyester resin and the amount of the ester group of the ester wax are more preferable, the crystallization of the ester wax after melting becomes faster, and the adhesion of ejected paper is further improved.

The toner may contain, in addition to the ester wax, a known wax to the extent that the effect of the present disclosure is not impaired. Specific examples of the known wax include petroleum wax and a derivative thereof such as paraffin wax, microcrystalline wax, or petrolatum, montan wax and a derivative thereof, a hydrocarbon wax obtained through a Fischer-Tropsch method and a derivative thereof, and a polyolefin wax such as polyethylene.

In addition, the toner may contain an ester wax having a molecular weight of less than 650 to the extent that the effect of the present disclosure is not impaired. A content of the ester wax having a molecular weight of at least 650 in the wax is preferably 15 to 100 mass % and more preferably 25 to 100 mass %.

In addition, the toner particle may contain a resin other than the polyester resin described above. The content of the polyester resin is preferably 50.0 to 100.0 mass %, more preferably 60.0 to 100.0 mass %, and still more preferably 70.0 to 100.0 mass %, based on the mass of the binder resin. Within the above range, the effects of low-temperature fixability, releasability, and adhesion of ejected paper are more excellent.

In this case, a content of the dodecenylsuccinic acid unit in the total binder resin is preferably from 3 mass % to 20 mass % and more preferably from 5 mass % to 14 mass %.

The content of the dodecenylsuccinic acid unit in the total binder resin in the toner particle can be controlled by adjusting the contents of the polyester resin and other resins used in producing the toner particles.

In addition, it is preferable that the toner particle further contains a compound A that is at least one compound selected from the group consisting of a compound represented by the following Formula (4) and a compound represented by the following Formula (5). When the compound A is present, charge rising performance is improved, and an initial solid concentration is improved.

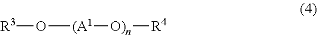

(In Formula (4), R³ represents an alkyl group having 8 to 24 carbon atoms, A¹ represents an ethylene group (—CH₂CH₂—) or a propylene group (—CH(CH₃)CH₂—), n is an integer of 5 to 60, and R⁴ is H, CH₂COOH, CH₂SO₃H, CH₂COONa, or CH₂SO₃Na.)

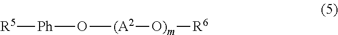

(In Formula (5), R⁵ represents an alkyl group having 8 to 24 carbon atoms, Ph represents a phenylene group, A² represents an ethylene group (—CH₂CH₂—) or a propylene group (—CH(CH₃)CH₂—), m is an integer of 5 to 60, and R⁶ is H, CH₂COOH, CH₂SO₃H, CH₂COONa, or CH₂SO₃Na.)

The effect of the compound A is due to the improvement in charge mobility in the toner particle derived from the polyether structure of the compound A. The structure of Formula (4) or (5) has high affinity with a polyester resin and preferably exhibits interaction of a polyether moiety. From the viewpoint of affinity between the compound A and the polyester resin, in Formula (4), R³ is preferably an alkyl group having 8 to 24 carbon atoms and more preferably 10 to 18 carbon atoms. In addition, in Formula (5), R⁵ is preferably an alkyl group having 8 to 24 carbon atoms and more preferably an alkyl group having 9 to 12 carbon atoms.

Furthermore, in order to obtain excellent charge mobility in the toner particle, in Formula (4), n is preferably from 5 to 60, more preferably from 6 to 30, and still more preferably from 8 to 20. In Formula (5), m is preferably from 5 to 60, more preferably from 6 to 30, and still more preferably from 8 to 20.

R⁴ and R⁶ are each H, CH₂COOH, CH₂SO₃H, CH₂COONa, or CH₂SO₃Na, preferably H, CH₂COOH, or CH₂SO₃H, and more preferably H.

An extraction amount of the compound A extracted with ethanol from the toner based on a mass of the toner is preferably 5 to 2,000 ppm by mass, more preferably 10 to 1,000 ppm by mass, and still more preferably 50 to 500 ppm by mass. Within this range, the generated charge becomes uniform on the surface of the toner particle, and thus, the charge rising performance is improved in a main body with a higher speed and the initial solid density is improved.

The extraction amount of the compound A is adjusted according to the amount of the compound A added during a toner production step. The compound A may be added during the toner particle production step or may be added after the toner particle is produced. From the viewpoint of improving the interaction with the polyester resin, it is preferable to add the compound A during the toner particle production step, and from the viewpoint of allowing the compound A to be uniformly present on the surface of the toner particle, it is preferable to add the compound A in an aqueous medium.

It is preferable that the toner particle contains a boron atom. A content of the boron atom based on the mass of the toner particles is preferably 1.0 to 100.0 ppm by mass because of excellent charge rising performance. Since the boron atom has a large ionization potential and is likely to form a covalent bond, it is considered that the boron atom interacts with a large number of ester groups of the polyester resin. As a result, it is considered that the boron atom is uniformly dispersed in the polyester resin containing a boron atom, and therefore, the charge retention of the toner is improved. Furthermore, it is considered that a pseudo-crosslinked state via the boron atom is formed by the interaction between the boron atom and a large number of ester groups of the polyester resin, and therefore, the transfer of the ester wax that is not crystallized is suppressed, and a toner having excellent long-term storage is obtained.

The content of the boron atom based on the mass of the toner particles is more preferably 1.0 to 50.0 ppm by mass, still more preferably 3.0 to 30.0 ppm by mass, and still more preferably 3.0 to 15.0 ppm by mass. The boron atom can be present by adding a compound containing a boron atom during the toner particle production step, and the content can be adjusted by the amount of the boron atom-containing compound added.

The toner contains a needle-shaped inorganic particle as an external additive. A number-average value of minor diameters of the needle-shaped inorganic particles is at least 10 nm, and a number-average value of aspect ratios of the needle-shaped inorganic particles is at least 5. Needle-shaped inorganic particles having a number-average value of minor diameters of at least 10 nm, which is longer than a chain length of the ester wax, and a number-average value of aspect ratios of at least 5, which exhibits a large surface area, are present in the toner after melting. Therefore, it is considered that the ester wax is finely dispersed around the needle-shaped inorganic particle.

The number-average value of the minor diameters of the needle-shaped inorganic particles is preferably 15 to 80 nm and more preferably 20 to 50 nm. Within this range, a relationship between the chain length of the ester wax and the length of the needle-shaped inorganic particle can be more preferable, such that the polyester resin and the ester wax can be finely dispersed, and the adhesion of ejected paper is more excellent.

Note that a number-average value of major diameters of the needle-shaped inorganic particles is preferably 30 to 700 nm and more preferably 200 to 650 nm.

The number-average value of the aspect ratios of the needle-shaped inorganic particles is preferably 10 to 80, more preferably 15 to 60, and still more preferably 20 to 40. Within this range, a surface area of the needle-shaped inorganic particle in the toner after melting can be set to a more preferable range, such that the ester wax can be finely dispersed, and the adhesion of ejected paper is more excellent.

In a case where the needle-shaped inorganic particle is a titanium oxide particle, the needle-shaped inorganic particle can be synthesized by a known method, for example, the method disclosed in Japanese Patent Application Publication No. 2004-315356. The minor diameter or the aspect ratio can also be controlled by a known method.

It is preferable that the needle-shaped inorganic particle includes a titanium oxide particle, and it is more preferable that the needle-shaped inorganic particle is a titanium oxide particle. By using the titanium oxide particle, the adhesion of ejected paper is excellent. This is considered to be because the ester wax is finely dispersed around hydrophobic titanium oxide in the molten polyester resin.

A content of the titanium oxide particle in the toner is preferably 0.10 to 2.00 parts by mass, more preferably 0.20 to 1.00 parts by mass, and still more preferably 0.40 to 0.70 parts by mass, with respect to 100 parts by mass of the toner particles. Within this range, a surface area of the titanium oxide particle in the toner after melting can be set to a more excellent range, such that the polyester resin and the ester wax can be finely dispersed, and the adhesion of ejected paper is more excellent.

When a content of the ester wax based on the mass of the toner particles is Y (mass %) and a content of the titanium oxide particle based on the mass of the toner is Z (mass %), the following Formula (3) is preferably satisfied.

$$0.02 \leq Z / Y \leq 4. \qquad ( 3 )$$

Z/Y is more preferably 0.030 to 0.150 and still more preferably 0.040 to 0.100. Within this range, the amount of the titanium oxide particles can be set to a more preferable range with respect to the amount of the ester wax in the toner after melting, such that the polyester resin and the ester wax can be more finely dispersed, and the adhesion of ejected paper is more excellent.

### Components of Toner

Each component constituting the toner and a method of producing a toner will be described in more detail.

### Binder Resin

The toner particle contains a binder resin. The binder resin contains a polyester resin. The binder resin may contain a resin other than the polyester resin as described above. It is preferable that the binder resin contains a polyester resin in an amount of at least 50 mass %. Examples of the binder resin other than the polyester resin are as follows.

The binder resin is not particularly limited, and examples thereof include a styrene acrylic resin, an epoxy resin, a polyurethane resin, a polyamide resin, a cellulose resin, a polyether resin, and a mixed resin or a composite resin thereof. A styrene acrylic resin or a polyester resin is preferable from the viewpoint of being inexpensive, easily available, and excellent in low-temperature fixability.

The polyester resin is obtained by selecting preferred compounds from a polycarboxylic acid, a polyol, a hydroxycarboxylic acid, and the like and combining the selected compounds, for example, synthesizing the compounds using a conventionally known method such as a transesterification method or a polycondensation method.

The polycarboxylic acid is a compound containing at least two carboxy groups in one molecule. Among them, the dicarboxylic acid is a compound containing two carboxy groups in one molecule, and is preferably used.

It is preferable that the polyester resin contains 2.6 to 20.0 mass % of a dodecenylsuccinic acid unit as a polycarboxylic acid. In addition, a content ratio of the dodecenylsuccinic acid unit is preferably 5 to 40 mol % and more preferably 10 to 25 mol % based on 100 mol % of the polycarboxylic acid component of the polyester resin. The polycarboxylic acid other than the dodecenylsuccinic acid in the polyester resin is, for example, as follows.

Examples of the dicarboxylic acid include dicarboxylic acids such as oxalic acid, succinic acid, glutaric acid, maleic acid, adipic acid, β-methyladipic acid, azelaic acid, sebacic acid, nonanedicarboxylic acid, decanedicarboxylic acid, undecanedicarboxylic acid, dodecanedicarboxylic acid, fumaric acid, citraconic acid, diglycolic acid, cyclohexane-3,5-diene-1,2-carboxylic acid, hexahydroterephthalic acid, malonic acid, pimelic acid, suberic acid, phthalic acid, terephthalic acid, isophthalic acid, tetrachlorophthalic acid, chlorophthalic acid, nitrophthalic acid, p-carboxyphenylacetic acid, p-phenylene diacetic acid, m-phenylene diacetic acid, o-phenylene diacetic acid, diphenylacetic acid, diphenyl-p,p′-dicarboxylic acid, naphthalene-1,4-dicarboxylic acid, naphthalene-1,5-dicarboxylic acid, naphthalene-2,6-dicarboxylic acid, anthracene dicarboxylic acid, and cyclohexane dicarboxylic acid.

Examples of the polycarboxylic acid other than the dicarboxylic acid include trimellitic acid, trimesic acid, pyromellitic acid, naphthalene tricarboxylic acid, naphthalene tetracarboxylic acid, pyrene tricarboxylic acid, pyrene tetracarboxylic acid, itaconic acid, and glutaconic acid. These compounds may be used alone or in combination of at least two kinds thereof.

The polyol is a compound containing at least two hydroxyl groups in one molecule. Among them, a diol is a compound containing two hydroxyl groups in one molecule, and is preferably used.

Specific examples thereof include ethylene glycol, diethylene glycol, triethylene glycol, 1,2-propylene glycol, 1,3-propylene glycol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, 1,14-eicosanediol, diethylene glycol, triethylene glycol, dipropylene glycol, polyethylene glycol, polypropylene glycol, polytetramethylene ether glycol, 1,4-cyclohexanediol, 1,4-cyclohexanedimethanol, 1,4-butenediol, neopentyl glycol, 1,4-cyclohexanediol, polytetramethylene glycol, hydrogenated bisphenol A, bisphenol A, bisphenol F, bisphenol S, and alkylene oxide (ethylene oxide, propylene oxide, butylene oxide, or the like) adducts of the bisphenols.

Among them, an alkylene glycol having 2 to 12 carbon atoms and an alkylene oxide adduct of a bisphenol are preferable, and an alkylene oxide adduct of a bisphenol and a combination thereof with an alkylene glycol having 2 to 12 carbon atoms are particularly preferable.

Examples of the trivalent or higher polyol include glycerin, trimethylolethane, trimethylolpropane, pentaerythritol, hexamethylolmelamine, hexaethylolmelamine, tetramethylolbenzoguanamine, tetraethylolbenzoguanamine, sorbitol, trisphenol PA, phenol novolac, cresol novolac, and an alkylene oxide adduct of the trivalent or higher polyphenol. These compounds may be used alone or in combination of at least two kinds thereof.

More preferably, the polycarboxylic acid includes at least one selected from the group consisting of terephthalic acid, isophthalic acid, sebacic acid, and trimellitic acid in addition to dodecenylsuccinic acid.

More preferably, the polyol includes at least one selected from the group consisting of an alkylene oxide (ethylene oxide or propylene oxide) adduct of bisphenol A (for example, 1 to 10 moles and preferably 1 to 5 moles) and an alkylene glycol having 2 to 6 carbon atoms.

A weight-average molecular weight Mw of the polyester resin is preferably 10,000 to 100,000 and more preferably 20,000 to 50,000.

An acid value of the polyester resin is preferably 10.0 to 40.0 mgKOH/g and more preferably 15.0 to 25.0 mgKOH/g. A hydroxyl value of the polyester resin is preferably 20.0 to 50.0 mgKOH/g and more preferably 25.0 to 35.0 mgKOH/g.

Examples of styrene acrylic resins include homopolymers comprising polymerizable monomers listed below, copolymers obtained by combining two or more of these polymerizable monomers, and mixtures of these.

Styrene-based monomers such as styrene, α-methylstyrene, β-methylstyrene, o-methylstyrene, m-methylstyrene, p-methylstyrene, 2,4-dimethylstyrene, p-n-butylstyrene, p-tert-butylstyrene, p-n-hexylstyrene, p-n-octylstyrene, p-n-nonylstyrene, p-n-decylstyrene, p-n-dodecylstyrene, p-methoxystyrene and p-phenylstyrene; (meth)acrylic monomers such as methyl (meth)acrylate, ethyl (meth)acrylate, n-propyl (meth)acrylate, iso-propyl (meth)acrylate, n-butyl (meth)acrylate, iso-butyl (meth)acrylate, tert-butyl (meth)acrylate, n-amyl (meth)acrylate, n-hexyl (meth)acrylate, 2-ethylhexyl (meth)acrylate, n-octyl (meth)acrylate, n-nonyl (meth)acrylate, cyclohexyl (meth)acrylate, benzyl (meth)acrylate, dimethyl phosphate ethyl (meth)acrylate, diethyl phosphate ethyl (meth)acrylate, dibutyl phosphate ethyl (meth)acrylate, 2-benzoyloxyethyl (meth)acrylate, (meth)acrylonitrile, 2-hydroxyethyl (meth)acrylate, (meth)acrylic acid and maleic acid;

Vinyl ether-based monomers such as vinyl methyl ether and vinyl isobutyl ether; and vinyl ketone-based monomers such as vinyl methyl ketone, vinyl ethyl ketone and vinyl isopropenyl ketone;

Polyolefins of ethylene, propylene, butadiene, and the like.

The styrene acrylic resin can be obtained using a polyfunctional polymerizable monomer if necessary. Examples of polyfunctional polymerizable monomers include diethylene glycol di(meth)acrylate, triethylene glycol di(meth)acrylate, tetraethylene glycol di(meth)acrylate, polyethylene glycol di(meth)acrylate, 1,6-hexane diol di(meth)acrylate, neopentyl glycol di(meth)acrylate, tripropylene glycol di(meth)acrylate, polypropylene glycol di(meth)acrylate, 2,2′-bis(4-((meth)acryloxydiethoxy)phenyl)propane, trimethylolpropane tri(meth)acrylate, tetramethylolpropane tetra(meth)acrylate, divinylbenzene, divinylnaphthalene and divinyl ether.

In addition, it is possible to further add well-known chain transfer agents and polymerization inhibitors in order to control the degree of polymerization.

Examples of polymerization initiators used for obtaining the styrene acrylic resin include organic peroxide-based initiators and azo-based polymerization initiators.

Examples of organic peroxide-based initiators include benzoyl peroxide, lauroyl peroxide, di-α-cumyl peroxide, 2,5-dimethyl-2,5-bis(benzoyl peroxy)hexane, bis(4-t-butylcyclohexyl) peroxydicarbonate, 1,1-bis(t-butyl peroxy)cyclododecane, t-butyl peroxymaleic acid, bis(t-butyl peroxy)isophthalate, methyl ethyl ketone peroxide, tert-butyl peroxy-2-ethylhexanoate, diisopropyl peroxycarbonate, cumene hydroperoxide, 2,4-dichlorobenzoyl peroxide and tert-butyl-peroxypivalate.

Examples of azo type initiators include 2,2′-azobis(2,4-dimethylvaleronitrile), 2,2′-azobisisobutyronitrile, 1,1′-azobis(cyclohexane-1-carbontrile), 2,2′-azobis-4-methoxy-2,4-dimethylvaleronitrile, azobis(methylbutyronitrile) and 2,2′-azobis-(methylisobutyrate).

In addition, a redox type initiator obtained by combining an oxidizing substance with a reducing substance can be used as a polymerization initiator.

Examples of oxidizing substances include inorganic peroxides such as hydrogen peroxide and persulfates (sodium salts, potassium salts and ammonium salts), and oxidizing metal salts such as tetravalent cerium salts.

Examples of reducing substances include reducing metal salts (divalent iron salts, monovalent copper salts and trivalent chromium salts), ammonia, amino compounds such as lower amines (amines having from 1 to 6 carbon atoms, such as methylamine and ethylamine) and hydroxylamine, reducing sulfur compounds such as sodium thiosulfate, sodium hydrosulfite, sodium hydrogen sulfite, sodium sulfite and aldehyde sulfoxylates, lower alcohols (having from 1 to 6 carbon atoms), ascorbic acid and salts thereof, and lower aldehydes (having from 1 to 6 carbon atoms).

The polymerization initiator is selected with reference to 10-hour half-life decomposition temperatures, and can be a single polymerization initiator or a mixture thereof. The added amount of polymerization initiator varies according to the target degree of polymerization, but is generally an amount of from 0.5 parts by mass to 20.0 parts by mass relative to 100.0 parts by mass of polymerizable monomer.

### Compound A

It is preferable that the toner particle contains a compound A that is at least one compound selected from the group consisting of a compound represented by Formula (4) and a compound represented by Formula (5).

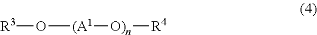

(In Formula (4), R³ represents an alkyl group having 8 to 24 carbon atoms, A¹ represents an ethylene group (—CH₂CH₂—) or a propylene group (—CH(CH₃)CH₂—), n is an integer of 5 to 60, and R⁴ is H, CH₂COOH, CH₂SO₃H, CH₂COONa, or CH₂SO₃Na.)

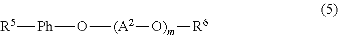

(In Formula (5), R⁵ represents an alkyl group having 8 to 24 carbon atoms, Ph represents a phenylene group, A² represents an ethylene group (—CH₂CH₂—) or a propylene group (—CH(CH₃)CH₂—), m is an integer of 5 to 60, and R⁶ is H, CH₂COOH, CH₂SO₃H, CH₂COONa, or CH₂SO₃Na.)

A method of producing the compound is not particularly limited, and any method can be used. For example, the toner can be obtained by adding a predetermined amount of ethylene oxide or propylene oxide to an aliphatic alcohol according to an application. A catalyst can be used for an addition reaction of propylene oxide. As the catalyst, an alkali hydroxide such as NaOH or KOH, or a catalyst containing magnesium oxide as a main component described in Japanese Patent Application Publication No. H8-323200 can be used. The former can obtain a polyethylene alkyl ether or a polypropylene alkyl ether having a relatively wide addition molar number distribution, and the latter can obtain a compound having a relatively narrow addition molar number distribution.

In addition, the compound A may be used as a surfactant exemplified in a method of producing a toner described below.

### Colorant

The toner particle may contain a colorant. A well-known pigment or dye can be used as the colorant. From the perspective of excellent weathering resistance, a pigment is preferred as the colorant.

Examples of cyan colorants include copper phthalocyanine compounds and derivatives thereof, anthraquinone compounds and basic dye lake compounds.

Specific examples thereof include the following. C.I. Pigment Blue 1, 7, 15, 15:1, 15:2, 15:3, 15:4, 60, 62 and 66.

Examples of magenta colorants include condensed azo compounds, diketopyrrolopyrrole compounds, anthraquinone compounds, quinacridone compounds, basic dye lake compounds, naphthol compounds, benzimidazolone compounds, thioindigo compounds and perylene compounds.

Specific examples thereof include the following. C.I. Pigment Red 2, 3, 5, 6, 7, 23, 48:2, 48:3, 48:4, 57:1, 81:1, 122, 144, 146, 150, 166, 169, 177, 184, 185, 202, 206, 220, 221 and 254, and C.I. Pigment Violet 19.

Examples of yellow colorants include condensed azo compounds, isoindolinone compounds, anthraquinone compounds, azo metal complexes, methine compounds and allylamide compounds.

Specific examples thereof include the following. C.I. Pigment Yellow 12, 13, 14, 15, 17, 62, 74, 83, 93, 94, 95, 97, 109, 110, 111, 120, 127, 128, 129, 147, 151, 154, 155, 168, 174, 175, 176, 180, 181, 185, 191 and 194.

Examples of black colorants include carbon black and materials colored black using the yellow colorants, magenta colorants and cyan colorants mentioned above.

It is possible to use one of these colorants in isolation, or a combination thereof, and these can be used in the form of solid solutions.

The content of the colorant is preferably from 1.0 parts by mass to 20.0 parts by mass relative to 100.0 parts by mass of the binder resin.

### Charge Control Agent and Charge Control Resin

The toner particle may contain a charge control agent or a charge control resin.

A well-known charge control agent can be used, and a charge control agent which has a fast triboelectric charging speed and can stably maintain a certain triboelectric charge quantity is particularly preferred. Furthermore, in a case where a toner particle is produced using a suspension polymerization method, a charge control agent which exhibits low polymerization inhibition properties and which is substantially insoluble in an aqueous medium is particularly preferred.

Examples of charge control agents that impart the toner particle with negative chargeability include monoazo metal compounds, acetylacetone metal compounds, aromatic oxycarboxylic acid, aromatic dicarboxylic acid, oxycarboxylic acid and dicarboxylic acid-based metal compounds, aromatic oxycarboxylic acids, aromatic mono- and poly-carboxylic acids and metal salts, anhydrides and esters thereof, phenol derivatives such as bisphenol, urea derivatives, metal-containing salicylic acid-based compounds, metal-containing naphthoic acid-based compounds, boron compounds, quaternary ammonium salts, calixarenes and charge control resins.

It is possible to use a polymer or copolymer having a sulfonic acid group, a sulfonic acid salt group or a sulfonic acid ester group as the charge control resin. It is particularly preferable for a polymer having a sulfonic acid group, a sulfonic acid salt group or a sulfonic acid ester group to contain a sulfonic acid group-containing acrylamide-based monomer or a sulfonic acid group-containing methacrylamide-based monomer at a copolymerization ratio of 2 mass % or more, and more preferably 5 mass % or more.

The charge control resin preferably has a glass transition temperature (Tg) of from 35° C. to 90° C., a peak molecular weight (Mp) of from 10000 to 30000, and a weight average molecular weight (Mw) of from 25000 to 50000. In a case where this is used, it is possible to impart preferred triboelectric charging characteristics without adversely affecting thermal characteristics required of the toner particle. Furthermore, if the charge control resin contains a sulfonic acid group, dispersibility of the charge control resin per se in the polymerizable monomer composition and dispersibility of the colorant and the like are improved, and tinting strength, transparency and triboelectric charging characteristics can be further improved.

It is possible to add one of these charge control agents or charge control resins in isolation, or a combination of two or more types thereof.

The added amount of the charge control agent or charge control resin is preferably from 0.01 parts by mass to 20.0 parts by mass, and more preferably from 0.5 parts by mass to 10.0 parts by mass, relative to 100.0 parts by mass of the binder resin.

### Method of Producing Toner

A method of producing a toner is not particularly limited, and a known method such as a pulverization method, a suspension polymerization method, a dissolution suspension method, an emulsion aggregation method, or a dispersion polymerization method can be used. Here, the toner is preferably produced by an emulsion aggregation method.

The method of producing a toner includes the following steps (1) to (3) in this order:
(1) a dispersion step of preparing a resin fine particle dispersion containing a resin such as a binder resin, and a dispersion step of preparing a wax fine particle dispersion containing an ester wax;
(2) an aggregation step of aggregating resin fine particles contained in the resin fine particle dispersion and wax fine particles containing an ester wax to form an aggregate; and
(3) a fusion step of heating and fusing the aggregate.

The method is preferably a method of producing a toner in which a boron compound is added in at least one of the aggregation step and the fusion step.

In addition, the following steps (4) to (6) are performed in this order during or after the fusion step:
(4) a spheroidization step of further heating the aggregate by increasing a temperature;
(5) a cooling step of cooling the aggregate at a cooling rate of at least 0.1° C./sec; and
(6) an annealing step of heating and retaining the aggregate at a temperature equal to or higher than a crystallization temperature or a glass transition temperature of the resin.

When the toner is produced by an emulsion aggregation method, the shape of the toner can be controlled, and boric acid is easily uniformly dispersed in the vicinity of the surface of the toner, which is preferable. Hereinafter, the emulsion aggregation method will be described in detail.

### Emulsion Aggregation Method

The emulsion aggregation method is a method in which an aqueous dispersion of fine particles that is formed of a constituent material of a toner particle and sufficiently small with respect to a target particle diameter is prepared in advance, the fine particles are aggregated in an aqueous medium until a diameter reaches a particle diameter of the toner particle, and a resin is fused by heating or the like to produce toner particles.

That is, in the emulsion aggregation method, a toner particle is produced through a dispersion step of preparing a fine particle dispersion containing a constituent material of a toner particle, an aggregation step of aggregating fine particles containing a constituent material of the toner particle and controlling a particle diameter until the particle diameter of the toner particle is obtained, a fusion step of subjecting a resin contained in the obtained aggregated particle to melt adhesion, a spheroidization step of melting the resin by heating or the like and controlling a surface profile of a toner, a cooling step, a metal removal step of filtering the obtained toner and removing excessive polyvalent metal ions, a filtration and washing step of washing the toner particles with ion exchanged water or the like, and a step of removing moisture of the washed toner particles and drying the toner particles.

### Step of Preparing Resin Fine Particle Dispersion (Dispersion Step)

The resin fine particle dispersion can be prepared by known methods, but is not limited to these methods. Examples of the known method include an emulsion polymerization method, a self-emulsification method, a phase inversion emulsification method in which an aqueous medium is added to a resin solution dissolved in an organic solvent to emulsify the resin, and a forced emulsification method in which a resin is forcibly emulsified by a high-temperature treatment in an aqueous medium without using an organic solvent.

Specifically, a resin is dissolved in an organic solvent in which the resin can be dissolved, and a surfactant or a basic compound is added. In this case, when the resin is a crystalline resin having a melting point, the resin only needs to be heated to a temperature equal to or higher than the melting point to be dissolved. Subsequently, an aqueous medium is slowly added to precipitate resin fine particles while stirring with a homogenizer or the like. Thereafter, the solvent is removed by heating or reducing the pressure to prepare an aqueous dispersion of resin fine particles. As the organic solvent used to dissolve the resin, any organic solvent can be used as long as it can dissolve the resin, and it is preferable to use an organic solvent that forms a uniform phase with water such as toluene from the viewpoint of suppressing the generation of coarse powder.

The surfactant to be used in the emulsification is not particularly limited, and examples thereof include an anionic surfactant such as a sulfuric acid ester salt-based surfactant, a sulfonate-based surfactant, a carboxylate-based surfactant, a phosphoric acid ester-based surfactant, or a soap-based surfactant; a cationic surfactant such as an amine salt-based surfactant or a quaternary ammonium salt-based surfactant; and a nonionic surfactant such as a polyethylene glycol-based surfactant, an alkylphenol ethylene oxide adduct-based surfactant, or a polyhydric alcohol-based surfactant. The surfactants may be used alone or in combination of at least two kinds thereof.

Examples of the basic compound used in the dispersion step include an inorganic base such as sodium hydroxide or potassium hydroxide; and an organic base such as ammonia, triethylamine, trimethylamine, dimethylaminoethanol, or diethylaminoethanol. The basic compounds may be used alone or in combination of at least two kinds thereof.

In addition, a 50% particle diameter (D50) on a volume basis of resin fine particles in the aqueous dispersion of the resin fine particles is preferably 0.05 μm to 1.0 μm, and more preferably 0.05 μm to 0.4 μm. By adjusting the 50% particle diameter (D50) on a volume basis to the above range, it is easy to obtain toner particles having a volume-average particle diameter of 3 μm to 10 μm, which is an appropriate volume-average particle diameter of toner particles.

Note that a dynamic light scattering particle size distribution analyzer Nanotrac UPA-EX150 (manufactured by Nikkiso Co., Ltd.) is used to measure the 50% particle diameter (D50) on a volume basis.

### Wax Fine Particle Dispersion

The wax fine particle dispersion containing an ester wax can be prepared by the following known methods, but is not limited to these methods.

The wax fine particle dispersion can be prepared by adding a wax to an aqueous medium containing a surfactant, heating the mixture to a temperature equal to or higher than a melting point of the wax, dispersing the mixture in the form of particles with a homogenizer (for example, “CLEARMIX W Motion” manufactured by M Technique Co., Ltd.) or a pressure discharge type disperser (for example, “Gaulin homogenizer” manufactured by Gaulin Corporation) having a strong shearing ability, and then cooling the mixture to a temperature lower than the melting point of the wax.

A dispersion particle diameter of the wax fine particle dispersion in the aqueous dispersion is preferably 0.03 μm to 1.0 μm and more preferably 0.1 μm to 0.5 μm as a 50% particle diameter (D50) on a volume basis. In addition, it is preferable that a coarse particle of at least 1 μm is not present.

Note that the dispersion particle diameter of the wax fine particle dispersion dispersed in the aqueous medium can be measured with a dynamic light scattering particle size distribution analyzer (Nanotrac UPA-EX150: manufactured by Nikkiso Co., Ltd.).

### Colorant Fine Particle Dispersion

If necessary, a colorant fine particle dispersion may be used. The colorant fine particle dispersion can be prepared by the following known methods, but is not limited to these methods. The colorant fine particle dispersion can be prepared by mixing a colorant, an aqueous medium, and a dispersing agent with a mixing machine such as a known stirrer, emulsifier, or disperser. As the dispersing agent used herein, a known dispersing agent such as a surfactant or a polymer dispersing agent can be used.

Any dispersing agent of the surfactant and the polymer dispersing agent can be removed in a washing step described below, and a surfactant is preferable from the viewpoint of washing efficiency.

Examples of the surfactant include an anionic surfactant such as a sulfuric acid ester salt-based surfactant, a sulfonate-based surfactant, a phosphoric acid ester-based surfactant, or a soap-based surfactant; a cationic surfactant such as an amine salt-based surfactant or a quaternary ammonium salt-based surfactant; and a nonionic surfactant such as a polyethylene glycol-based surfactant, an alkylphenol ethylene oxide adduct-based surfactant, or a polyhydric alcohol-based surfactant. Among them, a nonionic surfactant or an anionic surfactant is preferable. In addition, a nonionic surfactant and an anionic surfactant may be used in combination. The surfactants may be used alone or in combination of at least two kinds thereof. A concentration of the surfactant in the aqueous medium is preferably 0.5 mass % to 5 mass %.

A content of the colorant fine particles in the colorant fine particle dispersion is not particularly limited, and is preferably 1 mass % to 30 mass % with respect to the total mass of the colorant fine particle dispersion.

In addition, it is preferable that a dispersion particle diameter of the colorant fine particles in the aqueous dispersion of the colorant has a 50% particle diameter (D50) on a volume basis of not more than 0.5 μm from the viewpoint of the dispersibility of the colorant in the finally obtained toner. In addition, for the same reason, a 90% particle diameter (D90) on a volume basis is preferably not more than 2 μm. Note that the dispersion particle diameter of the colorant fine particles dispersed in the aqueous medium is measured with a dynamic light scattering particle size distribution analyzer (Nanotrac UPA-EX150: manufactured by Nikkiso Co., Ltd.).

Examples of the mixing machine such as a known stirrer, emulsifier, or disperser used when dispersing the colorant in the aqueous medium include an ultrasonic homogenizer, a jet mill, a pressure type homogenizer, a colloid mill, a ball mill, a Sandoz mill, and a paint shaker. These mixers may be used alone or in combination.

### Mixing Step

In the mixing step, a mixed solution obtained by mixing the resin fine particle dispersion and the wax fine particle dispersion, and as necessary, the colorant fine particle dispersion is prepared. The mixing step can be performed using a known mixing device such as a homogenizer or a mixer.

### Step of Forming Aggregate Particles (Aggregation Step)

In the aggregation step, fine particles contained in the mixed solution prepared in the mixing step are aggregated to form an aggregate having a target particle diameter. In this case, a flocculant is added and mixed, and at least one of heating and mechanical power is appropriately added as necessary to form an aggregate obtained by aggregating resin fine particles, wax fine particles, and colorant fine particles.

Examples of the flocculant include a cationic surfactant of a quaternary salt and an organic flocculant such as polyethyleneimine; an inorganic metal salt such as sodium sulfate, sodium nitrate, sodium chloride, calcium chloride, or calcium nitrate; an inorganic ammonium salt such as ammonium sulfate, ammonium chloride, or ammonium nitrate; and an inorganic flocculant such as a divalent or higher metal complex. In addition, it is also possible to add an acid so as to cause soft aggregation by lowering the pH, and for example, sulfuric acid, nitric acid, or the like can be used.

The flocculant may be added in the form of either a dry powder or an aqueous solution dissolved in an aqueous medium, and in order to cause uniform aggregation, it is preferable to add the flocculant in the form of an aqueous solution. In addition, the addition and mixing of the flocculant are preferably performed at a temperature equal to or lower than a glass transition temperature or a melting point of the resin contained in the mixed solution. By performing mixing under these temperature conditions, aggregation proceeds relatively uniformly. The flocculant can be mixed into the mixed solution using a known mixing device such as a homogenizer or a mixer. The aggregation step is a step of forming an aggregate having a toner particle diameter in an aqueous medium. A volume-average particle diameter of the aggregates produced in the aggregation step is preferably 3 μm to 10 μm. The volume-average particle diameter can be measured using a particle size distribution analyzer (Coulter Multisizer III, manufactured by Beckman Coulter, Inc.) using the Coulter method.

### Shell Formation Step of Further Adding Resin Fine Particles Containing Resin For Shell to Dispersion Containing Aggregate and Aggregating Resin Fine Particles to Form Aggregate Having Shell

It is preferable to include a shell formation step of forming aggregated particles (core particles) by the aggregation step, and then further adding resin fine particles containing a resin for a shell and aggregating the resin fine particles to form a shell. That is, it is preferable that the toner particle includes a core particle containing a binder resin and a shell formed on a surface of the core particle. As the resin for a shell, the same resin as the binder resin may be used, or another resin may be used. The amount of the resin for a shell added is preferably from 5 parts by mass to 40 parts by mass and more preferably from 10 parts by mass to 35 parts by mass with respect to 100 parts by mass of the binder resin contained in the core particle.

The resin of the shell is not particularly limited, and the resin described above can be used as the binder resin. It is preferable that the resin of the shell includes a polyester resin. As the resin of the shell, the polyester resin containing a dodecenylsuccinic acid unit may be used as described above.

At the time of forming the shell, it is preferable to further add the compound A to the dispersion containing the aggregate together with the resin fine particles containing the resin for a shell so that the toner particle contains the compound A. This is because the compound A can be present in the binder resin and on the surface of the toner by adding the compound A at the time of shell formation.

In addition, in order to make it easy to contain boron in the toner particle at the time of forming the shell, it is preferable to add a boron compound to the dispersion containing the aggregate together with the resin fine particles containing the resin for a shell in the shell formation step.

The boron compound only needs to be boric acid or a compound that can be changed to boric acid by pH control or the like during toner production. Examples of the boron compound include at least one selected from the group consisting of boric acid, borax, organic boric acid, a borate, and a borate ester. For example, it is sufficient that a boron compound is added, and control is performed so that boric acid is contained in the aggregate. Preferably, the pH is controlled to acidic conditions in the aggregation step, and the shell formation step is performed.

In the shell formation step, the presence of boric acid makes it easy to uniformly form the aggregation of the resin for a shell to the core particle, such that the area of the wax domain in the vicinity of the surface can be reduced.

Boric acid only needs to be present in the aggregate in an unsubstituted state. The boron compound is preferably at least one selected from the group consisting of boric acid and borax. When the toner is produced in an aqueous medium, it is preferable to add a borate as a boron compound from the viewpoint of reactivity and production stability. Specifically, it is more preferable that the boron compound includes at least one selected from the group consisting of sodium tetraborate, borax, and ammonium borate, and borax is still more preferable.

Borax is represented by a decahydrate of sodium tetraborate Na₂B₄O₇, and is changed to boric acid in an acidic aqueous solution. Therefore, borax is preferably used when used in an acidic environment in an aqueous medium. As an addition method, the boron compound may be added in any form of a dry powder and an aqueous solution dissolved in an aqueous medium, and in order to cause uniform aggregation, the boron compound is preferably added in the form of an aqueous solution. A concentration of the aqueous solution may be appropriately changed according to the concentration contained in the toner, and is, for example, 1 to 20 mass %. In order to change to boric acid, it is preferable to set the pH to an acidic condition before addition, during addition, or after addition. The pH may be controlled to, for example, 1.5 to 5.0, preferably 2.0 to 4.0.

### Step of Obtaining Dispersion Containing Toner Particles (Fusion Step)

In the fusion step, the dispersion containing the aggregate obtained in the aggregation step is first subjected to a stop of aggregation under stirring similar to the aggregation step. The aggregation is stopped by adding an aggregation stopping agent such as a base, a chelate compound, or an inorganic salt compound such as sodium chloride that can adjust a pH.

After the dispersion state of the aggregated particles in the dispersion becomes stable by the action of the aggregation stopping agent, the dispersion is heated to a temperature equal to or higher than a glass transition temperature or a melting point of a resin such as a binder resin, and the aggregated particles are fused to adjust the particle diameter to a desired particle diameter. Note that a 50% particle diameter (D50) on a volume basis of the toner particles is preferably 3 μm to 10 μm.

### Step of Obtaining Toner Having Desired Surface Profile (Spheroidization Step)

During the fusion step or after the fusion step, the temperature is preferably further increased to perform a spheroidization step in which the toner particles are retained to a desired circularity or surface profile. A specific temperature of the spheroidization step is, for example, 85° C. or higher, preferably 90° C. or higher, and preferably 95° C. or lower. Examples of a heating time in the spheroidization step include heating times of at least 1 hour, at least 2 hours, and at least 3 hours. An upper limit thereof is, for example, not more than 5 hours. By the step, a hydrogen bond derived from boric acid is easily formed in the toner particle.

### Cooling Step

After the spheroidization step, it is preferable to perform a cooling step of cooling the temperature of the dispersion containing the obtained toner particles by controlling a cooling rate to a temperature lower than a crystallization temperature or a glass transition temperature of each of crystalline components of a resin such as a binder resin and a wax such as an ester wax. Through the cooling step, a change in the domain shape associated with the crystallization of the crystalline component of the wax can be suppressed. As a result, it becomes easy to control a ratio of the domain area of the crystalline component by the ester wax in the vicinity of the toner particle surface.

A specific cooling rate is at least 0.1° C./sec, preferably at least 0.5° C./sec, more preferably at least 2° C./sec, and still more preferably at least 4° C./sec. An upper limit thereof is, for example, not more than 20° C./sec or not more than 15° C./sec.

### Annealing Step

After the cooling step, an annealing step of heating and retaining at a temperature equal to or higher than the crystallization temperature of the resin or equal to or higher than the glass transition temperature and equal to or lower than the crystallization temperature of the ester wax may be performed. Through the annealing step, the crystalline component compatible with the resin of the toner particle is crystallized, and the change in the domain shape can be further suppressed.

### Post-Treatment Step

In the method of producing a toner, a post-treatment step such as a washing step, a solid-liquid separation step, or a drying step may be further performed, and a toner particle in a dried state is obtained by performing the post-treatment step.

### External Addition Step

A needle-shaped inorganic particle is externally added to the obtained toner particle. In addition to the needle-shaped inorganic particle, an external additive such as a silica fine particle may be added to the toner particle. It is preferable that the toner contains a silica fine particle. A content of the silica fine particles is preferably 1.0 to 10.0 parts by mass and more preferably 2.0 to 5.0 parts by mass with respect to 100 parts by mass of the toner particles.

As the external addition conditions, a fixed state of the external additive and the coated state of the toner particle with the external additive can be arbitrarily controlled by a rotation speed rpm of a stirring spring provided in an external addition machine and an external addition time.

It is effective to increase a number of revolutions and increase the external addition time in order to more firmly perform fixing, and in particular, the fixing strength can be further increased by increasing the number of revolutions. In addition, since the external additive particles having a small particle diameter form an aggregate, the toner particle is coated with the external additive while being subjected to a deagglomeration treatment by controlling the external addition conditions. The deagglomeration can be enhanced by increasing the number of revolutions and increasing the external addition time, and in order to further advance the deagglomeration while suppressing the fixing strength, it is effective to suppress the number of revolutions and increase the external addition time.

A weight-average particle diameter (D4) of the toner is preferably 4.0 to 12.0 μm and more preferably 4.0 to 8.0 μm.

Next, a cartridge and an image forming apparatus that can use the toner of the present disclosure will be described in detail.

The cartridge of the present disclosure is a cartridge attachable to and detachable from an image forming apparatus, and includes a toner and a toner container that contains the toner. The toner contained in the toner container is the toner of the present disclosure described above. The cartridge of the present disclosure may further include an electrostatic latent image bearing member, a charging member that charges the electrostatic latent image bearing member, and a toner carrying member that carries a toner and transports the toner to the electrostatic latent image bearing member.

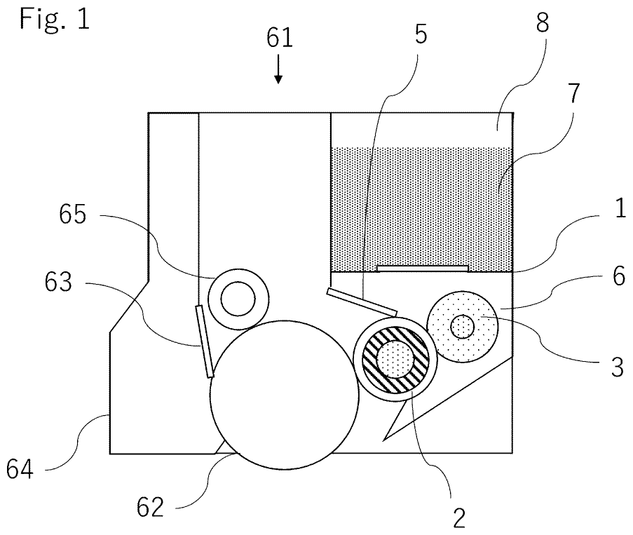

An embodiment of the cartridge is illustrated in FIG. 1. A cartridge 61 illustrated in FIG. 1 is attachable to and detachable from an image forming apparatus, and includes a toner container 8 that contains a toner 7. In addition, the cartridge 61 illustrated in FIG. 1 includes a developing apparatus 1. The developing apparatus 1 includes a developing roller (toner carrying member) 2, a toner supply roller 3, a developer container 6 that contains a developing blade 5, and a toner container 8 that contains the toner 7. The developing roller 2 is assembled so as to be in contact with the toner supply roller 3 and the developing blade 5. The toner supply roller 3 supplies the toner 7 to the developing roller 2. Furthermore, the cartridge 61 illustrated in FIG. 1 is a cartridge integrated with a photosensitive member (electrostatic latent image bearing member) 62, a cleaning blade 63, a waste toner container 64, and a charging roller (charging member) 65.

An electrophotographic apparatus of the present disclosure includes a toner, an electrostatic latent image bearing member, a charging member that charges the electrostatic latent image bearing member, an exposing unit that forms an electrostatic latent image by exposing the charged electrostatic latent image bearing member, and a developing unit that develops the electrostatic latent image formed on the electrostatic latent image bearing member using the toner carried on a toner carrying member. The toner is the toner of the present disclosure described above.

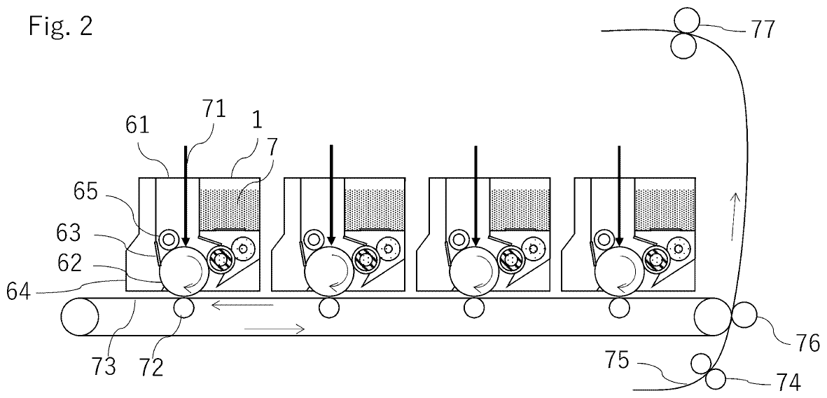

An embodiment of the electrophotographic apparatus (image forming apparatus) is illustrated in FIG. 2. A cartridge 61 including a developing apparatus 1, a photosensitive member 62, a cleaning blade 63, a waste toner container 64, and a charging roller 65 is attachable to and detachable from the electrophotographic apparatus illustrated in FIG. 2. Note that the photosensitive member 62, the cleaning blade 63, the waste toner container 64, and the charging roller 65 may be disposed in an electrophotographic apparatus main body.

The photosensitive member 62 rotates in a direction of an arrow and is uniformly charged by the charging roller 65 for charging the photosensitive member 62, and an electrostatic latent image is formed on a surface of the photosensitive member 62 by a laser beam 71 that is an exposure unit for writing the electrostatic latent image on the photosensitive member 62. The electrostatic latent image is developed by applying the toner 7 by the developing apparatus 1 disposed in contact with the photosensitive member 62, and is visualized as a toner image. The development is so-called reversal development for forming a toner image on an exposed portion.

The visualized toner image formed on the photosensitive member 62 is transferred to an endless belt-shaped transfer belt 73 by a transfer roller 72 that is a transfer member. The transferred toner image is transported to a secondary transfer position in an arrow direction by the transfer belt 73, and is transferred to paper 75 that is a recording medium fed by a paper feeding roller 74 by a secondary transfer roller 76. The paper 75 to which the toner image is transferred is subjected to fixing by a fixing apparatus 77 and ejected to the outside of the apparatus, and the printing operation is terminated.

### Method of Measuring Physical Properties

Next, a method of measuring each physical property according to the present disclosure will be described.

### Measurement of Weight-Average Particle Diameter (D4) and Number-Average Particle Diameter (D1) of Toner or Toner Particles

A weight-average particle diameter (D4) and a number-average particle diameter (D1) of the toner or the toner particles are measured with 25,000 effective measurement channels using a precision particle size distribution measuring device “Coulter Counter Multisizer 3” (registered trademark, manufactured by Beckman Coulter, Inc.) by a pore electrical resistance method provided with an aperture tube of 100 μm and a dedicated software “Beckman Coulter Multisizer 3 Version 3.51” (manufactured by Beckman Coulter, Inc.) attached for setting measurement conditions and analyzing measurement data, and the measurement data is analyzed and calculated.

As an electrolyte aqueous solution used for the measurement, an electrolyte aqueous solution prepared by dissolving special grade sodium chloride in ion exchanged water so as to have a concentration of about 1 mass %, for example, “ISOTON II” (manufactured by Beckman Coulter, Inc.) can be used.

Note that, before measurement and analysis, the dedicated software is set as follows.

On the “standard measurement method (SOM) change screen” of the dedicated software, the total count number in the control mode is set to 50000 particles, the number of times of measurements is set to 1, and a Kd value is set to a value obtained using “10.0 μm standard particles” (manufactured by Beckman Coulter, Inc.). A threshold and a noise level are automatically set by pressing a threshold/noise level measurement button. In addition, a current is set to 1600 μA, a gain is set to 2, an electrolyte is set to ISOTON II, and a flash of the aperture tube after the measurement is checked.

On the “conversion setting screen from pulse to particle diameter” of the dedicated software, a bin interval is set to a logarithmic particle diameter, a particle diameter bin is set to 256 particle diameter bins, and a particle diameter range is set to from 2 μm to 60 μm.

Specific measurement methods are as follows.

(1) About 200 ml of the electrolyte aqueous solution is put into a 250 ml round bottom glass beaker dedicated to the Multisizer 3 and set on a sample stand, and a stirrer rod is stirred at 24 rotation/sec counterclockwise. Then, contaminations and air bubbles in the aperture tube are removed by the “flash of the aperture tube” function of the dedicated software.

(2) About 30 ml of the electrolyte aqueous solution is put into a 100 ml flat-bottom beaker formed of glass, and about 0.3 ml of a diluent obtained by diluting “Contaminon N” (10 mass % of an aqueous solution of a neutral detergent for washing a precision measuring device at a pH of 7 containing a nonionic surfactant, an anionic surfactant, and an organic builder, manufactured by Wako Pure Chemical Industries, Ltd.) as a dispersing agent 3 times by mass with ion exchanged water is added thereto.

(3) Two oscillators having an oscillation frequency of 50 kHz are incorporated in a state of being shifted in phase by 180 degrees, a predetermined amount of ion exchanged water is put into a water tank of an ultrasonic disperser “Ultrasonic Dispersion System Tetora 150” (manufactured by Nikkaki Bios Co., Ltd.) having an electrical output of 120 W, and about 2 ml of Contaminon N is added to the water tank.

(4) The beaker in (2) is set in a beaker fixing hole of the ultrasonic disperser, and the ultrasonic disperser is operated. Then, a height position of the beaker is adjusted so that a resonance state of a liquid level of the electrolyte aqueous solution in the beaker is maximized.

(5) While the electrolyte aqueous solution in the beaker in (4) is irradiated with ultrasonic waves, about 10 mg of the toner or toner particles are added little by little to the electrolyte aqueous solution and dispersed. Then, the ultrasonic dispersion treatment is further continued for 60 seconds. Note that, in the ultrasonic dispersion, a water temperature in the water tank is appropriately adjusted to from 10° C. to 40° C.

(6) The electrolyte aqueous solution in (5) in which the toner or toner particles are dispersed is added dropwise to the round bottom beaker in (1) installed in a sample stand using a pipette, and a measurement concentration is adjusted to about 5%. Then, the measurement is performed until the number of measurement particles reaches 50000.

(7) The measurement data is analyzed with the dedicated software attached to the apparatus to calculate the weight-average particle diameter (D4). Note that the “average diameter” on the analysis/volume statistical value (arithmetic mean) screen when graph/volume % is set with the dedicated software is the weight-average particle diameter (D4), and the “average diameter” on the “analysis/number statistical value (arithmetic mean)” screen when graph/number % is set with the dedicated software is the number-average particle diameter (D1).

### Measurement of Acid Value

An acid value is the number of mg of potassium hydroxide required to neutralize an acid contained in 1 g of a sample. The acid value of the resin is measured according to JIS K 0070-1992, and specifically, the acid value of the resin is measured according to the following procedure.

### (1) Preparation of Reagent

1.0 g of phenolphthalein is dissolved in 90 ml of ethyl alcohol (95 vol %), and ion exchanged water is added to adjust the volume to 100 ml to obtain a phenolphthalein solution.

7 g of special grade potassium hydroxide is dissolved in 5 ml of water, and ethyl alcohol (95 vol %) is added to adjust the volume to 1 L. The mixture is put into an alkali-resistant container so as not to come into contact with carbon dioxide or the like, is allowed to stand for 3 days, and then is filtered to obtain a potassium hydroxide solution. The obtained potassium hydroxide solution is stored in an alkali-resistant container. The factor of the potassium hydroxide solution is determined from the amount of the potassium hydroxide solution required for neutralization by placing 25 ml of 0.1 mol/l hydrochloric acid into an Erlenmeyer flask, adding several drops of the phenolphthalein solution, and titrating with the potassium hydroxide solution. The 0.1 mol/l hydrochloric acid is prepared according to JIS K 8001-1998.

### (2) Operation

### (A) Main Test

2.0 g of a sample of a pulverized resin is weighed exactly in a 200 ml Erlenmeyer flask, 100 ml of a mixed solution of toluene/ethanol (2:1) is added thereto, and the mixture is dissolved for 5 hours. Next, several drops of the phenolphthalein solution are added as an indicator, and titration is performed using the potassium hydroxide solution. Note that an end point of the titration is when a light red color of the indicator lasts for about 30 seconds.

### (B) Blank Test

Titration is performed in the same manner as the above operation except that no sample is used (that is, only the mixed solution of toluene/ethanol (2:1) is used).

(3) The obtained result is substituted into the following formula to calculate the acid value.

$$A = [ ( C - B ) \times f \times 5.61 ] / S$$

Here, A is an acid value (mgKOH/g), B is the amount (ml) of the potassium hydroxide solution added in the blank test, C is the amount (ml) of the potassium hydroxide solution added in the main test, f is a factor of the potassium hydroxide solution, and S is a mass (g) of the sample.

### Method of Measuring Hydroxyl Value

A hydroxyl value is the number of mg of potassium hydroxide required to neutralize acetic acid bonded to a hydroxyl group when acetylating 1 g of a sample. The hydroxyl value of the binder resin is measured according to JIS K 0070-1992, and specifically, the hydroxyl value of the binder resin is measured according to the following procedure.

### (1) Preparation of Reagent

25 g of special grade acetic anhydride is put into 100 ml of a measuring flask, and pyridine is added to obtain the total amount of 100 ml, and the mixture is sufficiently shaken to obtain an acetylating reagent. The obtained acetylating reagent is stored in a brown bottle so as not to be exposed to moisture, carbon dioxide, or the like. 1.0 g of phenolphthalein is dissolved in 90 ml of ethyl alcohol (95 vol %), and ion exchanged water is added to adjust the volume to 100 ml to obtain a phenolphthalein solution.

35 g of special grade potassium hydroxide is dissolved in 20 ml of water, and ethyl alcohol (95 vol %) is added to adjust the volume to 1 L. The mixture is put into an alkali-resistant container so as not to come into contact with carbon dioxide or the like, is allowed to stand for 3 days, and then is filtered to obtain a potassium hydroxide solution. The obtained potassium hydroxide solution is stored in an alkali-resistant container. The factor of the potassium hydroxide solution is determined from the amount of the potassium hydroxide solution required for neutralization by placing 25 ml of 0.5 mol/l hydrochloric acid into an Erlenmeyer flask, adding several drops of the phenolphthalein solution, and titrating with the potassium hydroxide solution. The 0.5 mol/l hydrochloric acid is prepared according to JIS K 8001-1998.

### (2) Operation

### (A) Main Test

1.0 g of a sample is weighed exactly in a 200 ml round bottom flask, and 5.0 ml of the acetylating reagent is accurately added thereto using a whole pipette. At this time, when the sample is difficult to dissolve in the acetylating reagent, a small amount of special grade toluene is added to dissolve the sample.

A small funnel is placed on the mouth of the flask, and the flask bottom is heated by immersing about 1 cm in a glycerin bath at about 97° C. At this time, in order to prevent the temperature of the neck of the flask from rising due to the heat of the bath, it is preferable to cover the base of the neck of the flask with heavy paper with a round hole.

After 1 hour, the flask is removed from the glycerin bath and allowed to cool. After cooling, 1 ml of water is added from the funnel and shaken to hydrolyze acetic anhydride. For further complete hydrolysis, the flask is heated again in the glycerin bath for 10 minutes. After allowing to cool, the funnel and flask walls are washed with 5 ml of ethyl alcohol.

Several drops of the phenolphthalein solution are added as an indicator, and titration is performed using the potassium hydroxide solution. Note that an end point of the titration is when a light red color of the indicator lasts for about 30 seconds.

### (B) Blank Test

Titration is performed in the same manner as the above operation except that no sample is used.

(3) The obtained result is substituted into the following formula to calculate the hydroxyl value.

$$A = [ \{ ( B - C ) \times 28.05 \times f \} / S ] + D$$

Here, A is a hydroxyl value (mgKOH/g), B is the amount (ml) of the potassium hydroxide solution added in the blank test, C is the amount (ml) of the potassium hydroxide solution added in the main test, f is a factor of the potassium hydroxide solution, S is a mass (g) of the sample, and D is an acid value (mgKOH/g) of the sample.

### Method of Measuring Content X of Dodecenylsuccinic Acid Unit and Content of Isophthalic Acid Unit Based on Mass of Toner Particles

A content X of the dodecenylsuccinic acid unit and a content of the isophthalic acid unit are measured using a pyrolysis gas chromatography mass spectrometer (hereinafter, pyrolysis GC/MS) and NMR.

Specifically, the following operation is performed.

(1) 50 mg of the toner particles are weighed exactly in an 8 mL glass sample bottle, 1 mL of deuterated chloroform is added thereto, the glass sample bottle is covered with a lid, and the deuterated chloroform is dispersed and dissolved for 1 hour by an ultrasonic disperser. Next, filtration is performed with a membrane filter having a diameter of 0.4 μm, and a filtrate is recovered. At this time, the deuterated chloroform insoluble remains on the membrane filter.

(2) The filtrate is subjected to ¹H-NMR measurement and ¹³C-NMR measurement, components contained in the toner particles are assigned from the spectrum, and the contents of the isophthalic acid unit and the dodecenylsuccinic acid unit contained in the toner particles are calculated.

(3) When the identification is insufficient, analysis is further performed by pyrolysis GC/MS, an induction treatment such as methylation is performed as necessary, and composition analysis is performed.

### NMR Measurement Conditions

Bruker AVANCE 500 manufactured by Bruker Corporation
Measurement nuclei: ¹H, ¹³C
Measurement frequency: 500.1 MHz
Number of times of integration: 16, 2048
Measurement temperature: Room temperature

### Measurement Conditions of Pyrolysis GC/MS

Pyrolysis apparatus: TPS-700 manufactured by Japan Analytical Industry Co., Ltd.
Pyrolysis temperature: Appropriate value at 400° C. to 600° C.
GC/MS apparatus: ISQ manufactured by Thermo Fisher Scientific Inc.
Column: “HP5-MS” (Agilent/19091S-433), 30 m in length, 0.25 mm in inner diameter, 0.25 μm in film thickness
GC/MS Conditions
Inlet Conditions:
Inlet Temp: 250° C.
Split Flow: 50 mL/min.
GC temperature raising conditions: 40° C. (5 min)→10° C./min (300° C.)→300° C. (20 min)

### Measurement of Molecular Weight of Polyester Resin

The molecular weight (weight-average molecular weight Mw) of the polyester resin is measured by gel permeation chromatography (GPC) as follows.

First, the polyester resin is dissolved in tetrahydrofuran (THF) at room temperature for 24 hours. Then, the obtained solution is filtered through a solvent-resistant membrane filter “Myshori Disk” (manufactured by Tosoh Corporation) having a pore diameter of 0.2 μm to obtain a sample solution. Note that the sample solution is adjusted so that a concentration of the component soluble in THF is 0.8 mass %. The sample solution is used to measure under the following conditions.
Apparatus: HLC8120 GPC (detactor: RI) (manufactured by Tosoh Corporation)
Column: Two Shodex LF-404 and LF-404 (manufactured by Showa Denko K.K.)
Eluent: Tetrahydrofuran (THF)·
Flow rate: 1.0 ml/min.
Oven temperature: 40.0° C.
Sample injection amount: 0.10 ml

In the calculation of the molecular weight of the sample, a molecular weight calibration curve created using a standard polystyrene resin (for example, trade name '7 TSK standard polystyrene F-850, F-450, F-288, F-128, F-80, F-40, F-20, F-10, F-4, F-2, F-1, A-5000, A-2500, A-1000, and A-500” manufactured by Tosoh Corporation) is used.

### Identification of Molecular Structure of Ester Wax Contained in Toner

First, the wax contained in the toner is isolated from the toner by the following separation operation. The toner is dispersed in ethanol that is a poor solvent for the toner, and the temperature is raised to a temperature exceeding the melting point of the wax. At this time, pressurization may be performed as necessary. The wax exceeding the melting point by the operation is melted and extracted into ethanol. The wax can be separated from the toner by solid-liquid separation while being heated or further pressurized. Next, an extract is dried and solidified to obtain a wax. The ester wax can be isolated by separating the obtained wax for each molecular weight. By the present separation operation, even when a wax other than the ester wax is mixed, the ester wax can be isolated.

Next, a molecular structure of the isolated ester wax is identified. The molecular structure is identified by a pyrolysis gas chromatography mass spectrometer (hereinafter, pyrolysis GC/MS) and NMR.

Specifically, the following operations are performed.

(1) 50 mg of the toner is weighed exactly in an 8 mL glass sample bottle, 1 mL of deuterated chloroform is added thereto, the glass sample bottle is covered with a lid, and the deuterated chloroform is dispersed and dissolved for 1 hour by an ultrasonic disperser. Next, filtration is performed with a membrane filter having a diameter of 0.4 μm, and a filtrate is recovered. At this time, the deuterated chloroform insoluble remains on the membrane filter.

(2) The filtrate is subjected to 1H-NMR measurement, and a spectrum of the ester wax is assigned.

(3) Analysis is performed by pyrolysis GC/MS. If necessary, an induction treatment such as methylation is performed to calculate the molecular weight of the ester wax.

### NMR Measurement Conditions

Bruker AVANCE 500 manufactured by Bruker Corporation
Measurement nuclei: ¹H
Measurement frequency: 500.1 MHz
Number of times of integration: 16
Measurement temperature: Room temperature

### Measurement Conditions of Pyrolysis GC/MS

Pyrolysis apparatus: TPS-700 manufactured by Japan Analytical Industry Co., Ltd.
Pyrolysis temperature: Appropriate value at 400° C. to 600° C.
GC/MS apparatus: ISQ manufactured by Thermo Fisher Scientific Inc.
Column: “HP5-MS” (Agilent/19091S-433), 30 m in length, 0.25 mm in inner diameter, 0.25 μm in film thickness
GC/MS Conditions
Inlet Conditions:
Inlet Temp: 250° C.
Split Flow: 50 mL/min.
GC temperature raising conditions: 40° C. (5 min)→10° C./min (300° C.)→300° C. (20 min)
   Method of measuring Content Y of Ester wax Based on Mass of Toner Particles

The content Y of the ester wax based on the mass of the toner particles is calculated by the following procedure. First, a mass X1 of tetrahydrofuran (THF) soluble matter, a mass X2 of insoluble matter, and an incineration ash content X3 of insoluble matter in the toner particles are determined.

Specifically, 1.5 g of toner particles are weighed exactly, put into cylindrical filter paper (trade name: No. 86R, size 28×100 mm, manufactured by Advantec Toyo Kaisha, Ltd.) precisely weighed in advance, and set in Soxhlet extractor. Extraction is performed using 200 mL of tetrahydrofuran (THF) as a solvent for 20 hours, and extraction is performed at a reflux rate so that one extraction cycle of the solvent is about 5 minutes. The cylindrical filter paper after completion of extraction is taken out and air-dried and then vacuum-dried at 40° C. for 8 hours, the mass of the cylindrical filter paper containing the extraction residue is weighed, and the mass of the cylindrical filter paper is subtracted to obtain the mass of the extraction residue as the mass X2 (g) of tetrahydrofuran (THF) insoluble matter in the toner particles. In addition, the mass X1 (g) of the tetrahydrofuran (THF) soluble matter in the toner particles is determined from the following Formula (A).

X1=1.5−X2 (A)

Next, the content X3 (g) of components other than the resin component is determined by the following procedure. 1.5 g of the toner particles are weighed exactly in a pre-weighed 30 mL magnetic crucible. The magnetic crucible is placed in an electric furnace, heated at 900° C. for 3 hours, allowed to cool in the electric furnace, and allowed to cool in a desiccator at normal temperature for at least 1 hour, the mass of the crucible containing an incineration ash content is weighed, and the mass of the crucible is subtracted to calculate the incineration ash content X3 (g).

Furthermore, an extract obtained by the operation is filtered through a solvent-resistant membrane filter “Myshori Disk” (manufactured by Tosoh Corporation) having a pore diameter of 0.2 μm to obtain a sample solution. The sample solution is used to measure under the following conditions.
Apparatus: HLC8320 GPC (detactor: RI) (manufactured by Tosoh Corporation)
Column: Two Shodex LF-404 and LF-404 (manufactured by Showa Denko K.K.)
Eluent: Tetrahydrofuran (THF)
Flow rate: 1.0 ml/min.
Oven temperature: 40.0° C.
Sample injection amount: 0.10 ml

A total area S of a molecular weight distribution of the tetrahydrofuran (THF) soluble matter in the obtained toner particles and an area P derived from the ester wax having a peak molecular weight identified by the method described above are measured, and the content Y (mass %) of the ester wax in the toner particles can be determined from the following Calculation Formula (B).

$$Y = ( X 1 \times P / S ) / 1.5 \times 100 = \{ ( 1.5 - X 2 ) \times P / S \} / 1.5 \times 100 \qquad ( B )$$

### Method of Calculating SP Value of Ester Wax

The SP value of the ester wax is determined as follows according to the calculation method proposed by Fedors.

When the SP value (cal/cm³)^{0.5} of the ester wax is calculated, an evaporation energy (Δei) (cal/mol) and a molar volume (Δvi) (cm³/mol) are determined from the table described in “Polym. Eng. Sci., 14(2), 147-154 (1974)” with respect to atoms or atomic groups in the molecular structure of the identified ester wax, and the SP value is calculated by the following Formula (4).

$$SP value of ester wax = {( \sum Δ ei / \sum Δ vi )}^{0.5} \qquad Formula ( 4 )$$

Measurement of Extraction Amount of Compound A Extracted with Ethanol

The extraction amount of the compound A extracted with ethanol from the toner is determined as follows using 1H-NMR (nuclear magnetic resonance) measurement.

First, 50 ml of ethanol and 5 g of the toner are weighed exactly and mixed in a sample bin, and then irradiation with ultrasonic waves is performed for 30 minutes using a desk type ultrasonic cleaner (trade name: “B2510JMTH”, manufactured by Branson Ultrasonics Corporation) having an oscillation frequency of 42 kHz and an electrical output of 125 W. Thereafter, filtration is performed using a solvent-resistant membrane filter “Myshori Disk” (manufactured by Tosoh Corporation) having a pore diameter of 0.2 μm. Ethanol is removed from the filtrate by an evaporator, and then the filtrate is dissolved in deuterated chloroform (1% TMS) containing 10 mg of trimethylsilane (TMS), and analyzed by 1H-NMR to identify the structure of the compound A.

Separately, ¹H-NMR measurement of the identified compound A is performed, and the extraction amount (ppm) of the compound A extracted from the toner is calculated using a calibration curve based on the TMS intensity. Note that the calibration curve is created from the TMS intensity and the hydrogen-derived peak intensity ratio of the ethylene oxide group around from 3.0 to 5.0 ppm. The measuring device and the measurement conditions are as follows.

### NMR Measurement Conditions

Bruker AVANCE 500 manufactured by Bruker Corporation
Measurement nuclei: ¹H
Measurement frequency: 500.1 MHz
Number of times of integration: 1,024
Measurement temperature: Room temperature

### Method of Quantifying Boron Atom Based on Mass of Toner Particles

A content of the boron (B) atom based on the mass of the toner particles is quantified by an inductively coupled plasma mass spectrometer (ICP-MS). As the pretreatment, the toner particles are subjected to the following acidolysis to obtain a measurement solution for ICP-MS, and then ICP-MS measurement is performed, such that the content of the boron atom in the toner particles can be quantified.

### Pretreatment

Apparatus: Microwave pretreatment apparatus (ETHOS SEL) manufactured by
Milestone General K.K.
Sample amount: 50 mg

To 50 mg of the toner particles, 5.00 mL of 68% nitric acid (for atomic absorption analysis, manufactured by KANTO CHEMICAL CO., INC.) is added, and acidolysis is performed by the apparatus. Acidolysis is performed in two stages to obtain a desired measurement solution for ICP-MS. Acidolysis conditions are as follows.

### First Stage of Acidolysis

A heating temperature and a retention time at the time of acidolysis are set as follows:
normal temperature, 60° C. (2 minutes), 40° C. (2 minutes), 160° C. (6 minutes), 220° C. (8 minutes), 180° C. (1 minute), 220° C. (4 minutes), 220° C. (retained for 30 minutes), and cooling to room temperature (25° C.).

### Second Stage of Acidolysis

A heating temperature and a retention time at the time of acidolysis are set as follows:
adding of 3 mL of nitric acid, and normal temperature, 180° C. (5 minutes), 150° C. (1 minute), 220° C. (2 minutes), 220° C. (retained for 27 minutes), and cooling to room temperature (25° C.).

The volume of the solution obtained above is adjusted to 50 mL with ultrapure water. Further, the solution is diluted 100 times with ultrapure water to obtain a measurement solution for ICP-MS.

### Quantification of Boron Atom in Toner Particles by Inductively Coupled Plasma Mass Spectrometer

A content of a boron atom in the measurement solution for ICP-MS obtained above is quantified by the following apparatus and conditions.
Apparatus: Inductively coupled plasma mass spectrometer ICP-MS NexION 350D manufactured by PerkinElmer, Inc.
Measurement mode: Standard mode, calibration curve method
Element to be measured: Boron
Mass number: 11.0093
Scan mode: Peak hopping
Residence time: 50 ms
Detector: Dual
Peristaltic pump speed: 20.0 rpm

Thus, the content of the boron atom based on the mass of the toner particles is quantified.

Method of Obtaining Toner Particles by Removing External Additive from Toner

160 g of sucrose (manufactured by Kishida Chemical Co., Ltd.) is added to 100 mL of ion exchanged water and dissolved with hot water to prepare a sucrose concentrate. 31 g of the sucrose concentrate and 6 mL of Contaminon N (10 mass % of an aqueous solution of a neutral detergent for washing a precision measuring device at a pH of 7 containing a nonionic surfactant, an anionic surfactant, and an organic builder, manufactured by Wako Pure Chemical Industries, Ltd.) are put into a centrifuge tube (capacity: 50 ml). 1.0 g of the toner is added thereto, and the toner clump is broken with a spatula or the like. The centrifugation tube is shaken with a shaker (AS-IN sold by AS ONE Corporation) at 300 strokes per minute (spm) for 20 minutes. After shaking, the solution is replaced with a glass tube for a swing rotor (50 mL), and the glass tube is separated by a centrifuge (H-9R manufactured by KOKUSAN Co., Ltd.) at 3,500 rpm for 30 minutes.

By the operation, the toner particles and the external additive are separated. It is visually confirmed that the toner particles and the aqueous solution are sufficiently separated, and the toner particles separated to the uppermost layer are collected with a spatula or the like. The collected toner particles are filtered with a reduced pressure filter and then dried in a dryer for at least 1 hour to obtain a measurement sample. The operation is performed a plurality of times to secure the required amount.

In addition, the needle-shaped inorganic particles can be separated from the external additive obtained above by a known method, for example, a centrifugal separation method. The separated external additive is observed using a scanning electron microscope (for example, a scanning electron microscope “S-4800” (trade name, manufactured by Hitachi, Ltd.)) to confirm that there are only needle-shaped inorganic particles. The amount of the obtained needle-shaped inorganic particles is measured, and the content of the needle-shaped inorganic particles is calculated. Method of Measuring Major Diameter and Aspect Ratio of Needle-Shaped

### Inorganic Particle

The major diameter and the aspect ratio of the needle-shaped inorganic particle can be measured with a scanning electron microscope (for example, a scanning electron microscope “S-4800” (trade name, (manufactured by Hitachi, Ltd.)). In a field of view enlarged up to 50,000 times, the toner to which the needle-shaped inorganic fine particles are added is observed, and a major diameter and a minor diameter of primary particles of 100 needle-shaped inorganic particles are randomly measured. Then, a number-average value of the minor diameters and a number-average value of the aspect ratios are calculated. Here, the aspect ratio of the needle-shaped inorganic particle is calculated by the following formula. An observation magnification is suitably adjusted depending on the size of the needle-shaped inorganic particle.

Aspect ratio of needle-shaped inorganic particle=Major diameter of needle-shaped inorganic particle/Minor diameter of needle-shaped inorganic particle

### Measurement of Content of Titanium Oxide Particles in Toner

A content of the titanium oxide particles in the toner is measured by a standard addition method using wavelength-dispersive X-ray fluorescence analysis (XRF). At this time, titanium oxide particles having a major axis diameter of 145 nm and a minor axis diameter of 50 nm are used. By using an intensity of Ti, the titanium oxide particles can be quantified by wavelength-dispersive X-ray fluorescence analysis (XRF).

3 g of the toner is placed in an aluminum ring having a diameter of 30 mm, and pellets are prepared at a pressure of 10 tons. Then, the intensity of titanium (Ti) is obtained by wavelength-dispersive fluorescent X-ray analysis (XRF) (Ti intensity: −1). Note that the measurement conditions may be optimized by the XRF apparatus to be used, and a series of intensity measurements are all performed under the same conditions. Titanium oxide particles are added to the toner in an amount of 1.0 mass % with respect to the toner, and mixed by a coffee mill.

After mixing, the mixture is pelletized in the same manner as described above, and then the intensity of Ti is determined in the same manner as described above (Ti intensity: −2). In a sample obtained by adding and mixing 2.0 mass % and 3.0 mass % of the titanium oxide particles with respect to the toner in the same operation, the intensity of Ti is determined (Si intensity: −3, Si intensity: −4). A content (mass %) of the acid value titanium particles in the toner is calculated by a standard addition method using the Si intensity of −1 to 4.

### EXAMPLES

Hereinafter, the present disclosure will be described in more detail using Examples and Comparative Examples. The present disclosure is not limited at all by the following Examples as long as it does not depart from the gist thereof. Note that, in the description of the following Examples, “part(s)” are on a mass basis unless otherwise specified.

### Synthesis of Polyester Resin 1

500 parts by mass of bisphenol A-propylene oxide 2 mol adduct
460 parts by mass of bisphenol A-ethylene oxide 2 mol adduct
200 parts by mass of isophthalic acid
130 parts by mass of terephthalic acid
160 parts by mass of dodecenylsuccinic acid

The monomers were added to a flask equipped with a stirring device, a nitrogen inlet tube, a temperature sensor, and a rectification column, and the temperature was raised to 195° C. in 1 hour to confirm that the inside of the reaction system was uniformly stirred. To 100 parts of these monomers, 1.2 parts by mass of tin distearate was added. The temperature was further raised from 195° C. to 240° C. for 5 hours while generated water was distilled off, and a dehydration condensation reaction was further performed at 240° C. for 2 hours. Next, the temperature was lowered to 190° C., 40 parts by mass of trimellitic anhydride was gradually added, and the reaction was continued at 190° C. for 1 hour.

As a result, a polyester resin 1 having an acid value of 21.7 mgKOH/g, a hydroxyl value of 30.5 mgKOH/g, and a weight-average molecular weight of 32000 was obtained. The synthesis conditions and analysis results of the polyester resin 1 are shown in Tables 1 and 2.

### Synthesis of Polyester Resins 2 to 15

Polyester resins 2 to 15 were obtained in the same manner as in the synthesis example of the polyester resin 1 except that the raw materials used were changed as shown in Table 1 in the synthesis example of the polyester resin 1. The synthesis conditions and analysis results of the polyester resins 2 to 15 are shown in Tables 1 and 2.

TABLE 1

| | Charged raw materials Parts by mass | | | | | | | |
|---|---|---|---|---|---|---|---|---|
| | Alcohol monomer | | | Acid monomer | | | | |
| | EG | BPA-2PO | BPA-2EO | IPA | DoSA | TPA | SA | TMA |
| Polyester resin 1 | — | 500 | 460 | 200 | 160 | 130 | — | 40 |
| Polyester resin 2 | 30 | 500 | 430 | 110 | 120 | 250 | 60 | 50 |
| Polyester resin 3 | — | 500 | 460 | 80 | 160 | 250 | — | 40 |
| Polyester resin 4 | — | 500 | 460 | 40 | 160 | 290 | — | 40 |
| Polyester resin 5 | — | 500 | 460 | 330 | 160 | — | — | 40 |
| Polyester resin 6 | 30 | 500 | 430 | 450 | 130 | — | — | 30 |
| Polyester resin 7 | 50 | 500 | 410 | 500 | 100 | — | — | 30 |
| Polyester resin 8 | — | 500 | 460 | 200 | 45 | 130 | 115 | 40 |
| Polyester resin 9 | — | 500 | 460 | 200 | 40 | 130 | 120 | 40 |
| Polyester resin 10 | — | 500 | 460 | 180 | 300 | 130 | — | 10 |
| Polyester resin 11 | 20 | 500 | 440 | 160 | 380 | 130 | — | 10 |
| Polyester resin 12 | — | 500 | 460 | 200 | 70 | 130 | 90 | 40 |
| Polyester resin 13 | — | 500 | 460 | 200 | 60 | 130 | 100 | 40 |
| Polyester resin 14 | — | 500 | 460 | — | 240 | 330 | — | 30 |
| Polyester resin 15 | — | 500 | 460 | 200 | — | 130 | 160 | 40 |

EG: 1,2-Ethylene glycol
BPA-2PO: Bisphenol A-propylene oxide 2 mol adduct
BPA-2EO: Bisphenol A-ethylene oxide 2 mol adduct
IPA: Isophthalic acid
DoSA: Dodecenylsuccinic acid
TPA: Terephthalic acid
SA: Sebacic acid
TMA: Trimellitic anhydride

TABLE 2

| | Analysis results of polyester resin | | | | |
|---|---|---|---|---|---|
| | Content of monomer unit | | | | |
| | in acid monomer | | | | |
| | Mass % | | Weight- | | |
| | | Dodecenyl- | average | | |
| | Isophthalic | succinic | molecular | Acid | Hydroxyl |
| | acid | acid | weight | value | value |
| Polyester | 13.4 | 10.7 | 32000 | 21.7 | 30.5 |
| resin 1 | | | | | |
| Polyester | 7.1 | 7.7 | 31000 | 21.5 | 31.2 |
| resin 2 | | | | | |
| Polyester | 5.4 | 10.7 | 33000 | 20.6 | 31.6 |
| resin 3 | | | | | |
| Polyester | 2.7 | 10.7 | 30000 | 22.1 | 31.0 |
| resin 4 | | | | | |
| Polyester | 22.1 | 10.7 | 32000 | 21.8 | 28.7 |
| resin 5 | | | | | |
| Polyester | 28.7 | 8.3 | 34000 | 17.8 | 31.8 |
| resin 6 | | | | | |
| Polyester | 31.4 | 6.3 | 31000 | 17.4 | 32.5 |
| resin 7 | | | | | |
| Polyester | 13.4 | 3.0 | 30000 | 21.2 | 28.4 |
| resin 8 | | | | | |
| Polyester | 13.4 | 2.7 | 35000 | 20.8 | 28.1 |
| resin 9 | | | | | |
| Polyester | 11.4 | 19.0 | 31000 | 19.5 | 33.2 |
| resin 10 | | | | | |
| Polyester | 9.8 | 23.2 | 32000 | 17.2 | 31.6 |
| resin 11 | | | | | |
| Polyester | 13.4 | 4.7 | 31000 | 21.2 | 28.8 |
| resin 12 | | | | | |
| Polyester | 13.4 | 4.0 | 32000 | 20.2 | 28.6 |
| resin 13 | | | | | |
| Polyester | — | 15.4 | 35000 | 19.5 | 32.2 |
| resin 14 | | | | | |
| Polyester | 13.4 | — | 32000 | 21.0 | 28.0 |
| resin 15 | | | | | |

The unit of each of the acid value and the hydroxyl value is mgKOH/g.

### Preparation of Resin Particle Dispersion of Polyester Resin 1

To a container, 50 parts by mass of the methyl ethyl ketone and 20 parts by mass of isopropyl alcohol were added. Thereafter, 100 parts by mass of the polyester resin 1 was gradually added, stirred, and completely dissolved to obtain a polyester resin 1 solution. The container containing the polyester resin 1 solution was set to 65° C., a 10% ammonia aqueous solution was gradually added dropwise so that the total amount was 5 parts while stirring, and 230 parts of ion exchanged water was further gradually added dropwise at a rate of 10 ml/min to perform phase inversion emulsification. The pressure was further reduced with an evaporator to remove the solvent, thereby obtaining a resin particle dispersion of the polyester resin 1. A particle diameter of the resin particle dispersion of the polyester resin 1 was measured using a particle diameter distribution analyzer (LA-950 manufactured by HORIBA, Ltd.), and a volume-average particle diameter of the resin particle dispersion of the polyester resin 1 was 105 nm. In addition, a solid content of the resin particle dispersion of the polyester resin 1 was adjusted to 20 mass % by using ion exchanged water.

### Preparation of Resin Particle Dispersion of Polyester Resins 2 to 15

Resin particle dispersions of the polyester resins 2 to 15 were prepared in the same manner as in the preparation of the resin particle dispersion of the polyester resin 1 by using the polyester resins 2 to 15 instead of the polyester resin 1 in the preparation of the resin particle dispersion of the polyester resin 1.

### Preparation of Resin Particle Dispersion of Styrene Acrylic Resin 1

A styrene acrylic resin 1 containing styrene, butyl acrylate, and an acrylic acid copolymer (copolymerization ratio (wt %) styrene: 79.0, butyl acrylate: 18.5, acrylic acid: 2.5, weight-average molecular weight: 31,500, acid value: 18.7 mgKOH/g) was produced by a known preparation method. A resin particle dispersion of the styrene acrylic resin 1 was prepared in the same manner as in the preparation of the resin particle dispersion of the polyester resin 1 by changing the polyester resin 1 to the styrene acrylic resin 1 in the preparation of the resin particle dispersion of the polyester resin 1.

### Preparation of Dispersion of Crystalline Polyester Resin 1

A reaction of 220 parts by mass of sebacic acid as a polycarboxylic acid compound and 298 parts by mass of 1,12-dodecanediol as a polyhydric alcohol compound was performed to obtain a crystalline polyester resin 1. A weight-average molecular weight was 28,000 and an acid value was 18.0 mgKOH/g.

A resin particle dispersion of the crystalline polyester resin 1 was prepared in the same manner as in the preparation of the resin particle dispersion of the polyester resin 1 by changing the polyester resin 1 to the crystalline polyester resin 1 in the preparation of the resin particle dispersion of the polyester resin 1.

### Production Example of Ester Wax 1

10 parts of dipentaerythritol as an alcohol monomer and 70 parts of stearic acid as a carboxylic acid monomer were added to a reaction vessel equipped with a thermometer, a nitrogen inlet tube, a stirrer, a Dean-Stark trap, and a Dimroth condenser, and an esterification reaction was performed at 200° C. for 15 hours. To the obtained ester compound, 20 parts of toluene and 25 parts of isopropanol were added, 190 parts of a 10% potassium hydroxide aqueous solution in an amount equivalent to 1.5 times the acid value of the ester compound was added, and the mixture was stirred at 70° C. for 4 hours. Thereafter, the water tank was removed. Further, 20 parts of ion exchanged water was added, the mixture was stirred at 70° C. for 1 hour, and then the water tank was removed to perform washing. The washing step was repeated until the pH of the removed water tank became neutral.

Thereafter, the pressure was reduced under conditions of 200° C. and 1 kPa to remove the solvent, thereby obtaining dipentaerythritol hexastearate (ester wax 1) as an ester compound of dipentaerythritol and stearic acid, which is a final target product. The analysis results of the obtained ester wax 1 are shown in Table 3.

### Production Examples of Ester Waxes 2 to 7 and 9 to 11

Ester waxes 2 to 7 and 9 to 11 were obtained in the same manner as in the synthesis example of the ester wax 1 except that the raw materials used were changed as shown in Table 3 in the synthesis example of the ester wax 1. The synthesis conditions and analysis results of the obtained ester waxes 2 to 7 and 9 to 11 are shown in Table 3.

### Ester Wax 8

As an ester wax 8, refined carnauba wax special No. 1 powder manufactured by Nippon Wax Co., Ltd. was used. As a result of measuring a molecular weight of the ester wax by GPC analysis, the molecular weight was distributed in a range of 650 to 1050, the peak molecular weight was 850, and the melting point was 83° C.

### Hydrocarbon Wax 1

As the hydrocarbon wax, a hydrocarbon wax (HNP-9, manufactured by Nippon Seiro Co., Ltd.) was used.

TABLE 3

| | | | | | | Melting |
|---|---|---|---|---|---|---|
| | | | Acid | Molecular | SP | point |
| | Structure | Alcohol monomer | monomer | weight | value | ° C. |
| Ester wax 1 | Dipentaerythritol | Dipentaerythritol | Stearic acid | 1853 | 8.97 | 77 |
| | hexastearate | | | | | |
| Ester wax 2 | Pentaerythritol | Pentaerythritol | Behenic acid | 1426 | 8.87 | 71 |
| | tetrabehenate | | | | | |
| Ester wax 3 | Dibehenyl sebacate | Behenyl alcohol | Sebacic acid | 819 | 8.77 | 73 |
| Ester wax 4 | 1,6-Hexanediol | 1,6-Hexanediol | Stearic acid | 651 | 8.83 | 57 |
| | distearate | | | | | |
| Ester wax 5 | Pentaerythritol | Pentaerythritol | Palmitic acid | 1090 | 8.97 | 69 |
| | tetrapalmitate | | | | | |
| Ester wax 6 | Dipentaerythritol | Dipentaerythritol | Behenic acid | 2190 | 8.9 | 80 |
| | hexabehenate | | | | | |
| Ester wax 7 | 1,10-Decanediol | 1,10-Decanediol | Triacontanoic | 1045 | 8.72 | 88 |
| | ditriacontanate | | acid | | | |
| Ester wax 8 | Carnauba wax | — | — | *850 | 8.58 | 83 |
| | (main component: | | | | | |
| | myricyl montanate) | | | | | |
| Ester wax 9 | Dipentaerythritol | Dipentaerythritol | Palmitic acid | 1685 | 9.01 | 72 |
| | hexapalmitate | | | | | |
| Ester wax 10 | Distearyl | Stearyl alcohol | Terephthalic | 699 | 9.11 | 75 |
| | terephthalate | | acid | | | |
| Ester wax 11 | Behenyl behenate | Behenyl alcohol | Behenic acid | 649 | 8.585 | 73 |
| Hydrocarbon | HNP9 | — | — | 469 | 8.28 | — |
| wax 1 | | | | | | |

In Table 3, a unit of the SP value is (cal/cm³)^{0.5}. * peak molecular weight

### Preparation of Ester Wax Dispersion 1

45 parts of ester wax 1
5 parts of ionic surfactant Neogen RK (manufactured by DKS CO. Ltd.)
190 parts of ion exchanged water

The above components were added to a mixing vessel equipped with a stirring device, heated to 90° C., circulated to CLEARMIX W-Motion (manufactured by M Technique Co., Ltd.), and subjected to a dispersion treatment for 60 minutes. The conditions of the dispersion treatment were as follows.
Rotor outer diameter: 3 cm
Clearance: 0.3 mm
Number of revolutions of rotor: 19,000 r/min
Number of revolutions of screen: 19,000 r/min

After the dispersion treatment, cooling was performed to 40° C. under cooling treatment conditions of a number of revolutions of a rotor of 1,000 r/min, a number of revolutions of a screen of 0 r/min, and a cooling rate of 10° C./min to obtain an ester wax dispersion 1 dispersion having a volume-average particle diameter of 170 nm and a solid content of 20 mass %.

### Preparation of Ester Wax Dispersions 2 to 11

Ester wax dispersions 2 to 11 were obtained in the same manner as in the preparation of the ester wax dispersion 1 except that the ester wax 1 was changed to the ester waxes 2 to 11.

### Preparation of Hydrocarbon Wax Dispersion

45 parts of hydrocarbon wax 1 (HNP-9, manufactured by Nippon Seiro Co., Ltd.)
5 parts of ionic surfactant Neogen RK (manufactured by DKS CO. Ltd.)
190 parts of ion exchanged water

The above components were added to a mixing vessel equipped with a stirring device, heated to 90° C., circulated to CLEARMIX W-Motion (manufactured by M Technique Co., Ltd.), and subjected to a dispersion treatment for 60 minutes. The conditions of the dispersion treatment were as follows.
Rotor outer diameter: 3 cm
Clearance: 0.3 mm
Number of revolutions of rotor: 19,000 r/min
Number of revolutions of screen: 19,000 r/min

After the dispersion treatment, cooling was performed to 40° C. under cooling treatment conditions of a number of revolutions of a rotor of 1,000 r/min, a number of revolutions of a screen of 0 r/min, and a cooling rate of 10° C./min to obtain a hydrocarbon wax dispersion having a volume-average particle diameter of 160 nm and a solid content of 20 mass %.

### Production Example of Compound A1

280 parts by mass of 1-dodecanol and 15.5 parts by mass of potassium hydroxide were charged in a 2 L autoclave, dehydrated at 115° C. and 10.5 kPa, and then subjected to an addition reaction at 150° C. while 720 parts by mass of ethylene oxide was subjected to indentation at 0.3 MPa. After the reaction was completed, aging was performed at the same reaction temperature for 6 hours and then cooling was performed to 80° C. To the obtained reaction composition, 250 parts by mass of a synthetic adsorbent (KYOWAAD 600 S, manufactured by Kyowa Chemical Industry Co., Ltd.) was added, the mixture was treated at 4.0 kPa for 1 hour, and then the catalyst was removed by filtration, thereby obtaining a compound A1 shown in Table 4.

### Production Examples of Compounds A2 to A6

Compounds A2 to A6 shown in Table 4 were obtained in the same manner as in the synthesis example of the compound A1 except that the raw materials used were changed as shown in Table 4 in the synthesis example of the compound A1. Production Example of Compound A7

To a 1,000 mL five-necked flask equipped with a reflux tube, a dissolved oxygen concentration meter, and a stirring blade, 100 parts by mass of the compound A1, 5 parts by mass of 5% Pt-1% Bi/C (Lot. TP-2/0230 manufactured by Evonik Industries) as a catalyst, and 420 parts by mass of ion exchanged water were added. Then, the temperature was raised to 70° C. under a flow of nitrogen while stirring under a condition of 400 rpm, and after reaching 70° C., nitrogen was continuously flowed for 15 minutes. Thereafter, the mixture was circulated for 18 hours under a condition of 90 mL/min by switching to oxygen and reacted to obtain a compound A7 shown in Table 4.

TABLE 4

| | | | | | | | Average |
|---|---|---|---|---|---|---|---|
| | | | Alkyl | Ethylene | R³ or R⁵ | | addition |
| | | | alcohol | oxide | Number | | molar |
| Compound | | Kind of alkyl | Parts by | Parts by | of carbon | | number |
| No. | | alcohol | mass | mass | atoms | R⁴ or R⁶ | n or m |
| A1 | Formula (4) | 1-Dodecanol | 280 | 720 | 12 | H | 10 |
| A2 | Formula (4) | 1-Octanol | 280 | 720 | 8 | H | 7 |
| A3 | Formula (4) | 1-Dodecanol | 130 | 870 | 12 | H | 26 |
| A4 | Formula (4) | 1-Butanol | 280 | 720 | 4 | H | 4 |
| A5 | Formula (4) | 1-Dodecanol | 70 | 930 | 12 | H | 52 |
| A6 | Formula (5) | Nonylphenol | 320 | 680 | 9 | H | 10 |
| A7 | Formula (4) | 1-Dodecanol | 280 | 720 | 12 | CH₂COOH | 9 |

In the compounds A1 to A7, A1 and A2 are ethylene groups.

### Preparation of Colorant Particle Dispersion

45 parts of copper phthalocyanine (Pigment Blue 15:3)
5 parts of ionic surfactant Neogen RK (manufactured by DKS CO. Ltd.)
190 parts of ion exchanged water

The above components were mixed and dispersed for about 1 hour using a high pressure impact type disperser Nanomizer (manufactured by Yoshida Kikai Co., Ltd.) to prepare an aqueous dispersion (colorant fine particle dispersion) having a concentration of colorant fine particles of 20 mass % in which a colorant was dispersed.

### Production of Toner Particles 1

750 parts of resin particle dispersion of polyester resin 1
70 parts of colorant particle dispersion
120 parts of ester wax dispersion 1
1000 parts of ion exchanged water

First, as a core formation step, each of the materials was added to a round stainless flask and mixed. Subsequently, the mixture was dispersed at 5,000 r/min for 10 minutes using a homogenizer Ultra-Turrax T50 (manufactured by IKA). A 1.0% nitric acid aqueous solution was added to adjust the pH to 3.0, and then the mixed solution was heated to 45° C. using a stirring blade in a water bath for heating while appropriately adjusting a number of revolutions at which the mixed solution was stirred.

A volume-average particle diameter of the formed aggregated particles was appropriately checked using Coulter Multisizer III, and when aggregated particles (cores) of 5.0 μm were formed, the following materials were added and further stirred for 1 hour to form a shell as a shell formation step.
250 parts of resin particle dispersion of polyester resin 1
300 parts of ion exchanged water
100 parts of 3.0 mass % of aqueous solution of compound A1
50 parts of 2.0 mass % of borax aqueous solution
   (Borax, sodium tetraborate decahydrate, manufactured by FUJIFILM Wako Pure Chemical Corporation)

Thereafter, as a spheroidization step, a 5% sodium hydroxide aqueous solution was used to adjust the pH to 9.0, and heating was performed to 90° C. while stirring was continued.

Thereafter, an average circularity of the formed aggregated particles was appropriately measured by a flow particle image analyzer “FPIA-3000” (manufactured by Sysmex Corporation).

Heating was performed until the average circularity of the aggregated particles reached 0.970 (heating was performed for 3 hours), and then, as a cooling step, ice was rapidly added so that the cooling rate was at least 10° C./sec and cooling was performed to 25° C., thereby obtaining a dispersion of toner particles 1.

The dispersion of the toner particles 1 was neutralized by adding hydrochloric acid to adjust the pH to 5.0 to 7.0, and then solid-liquid separation was performed at a pressure of 0.3 MPa using a pressure filter to obtain a toner cake. The toner cake was reslurried with ion exchanged water to obtain a dispersion again, and then subjected to solid-liquid separation at a pressure of 0.3 MPa by the filter described above to obtain a toner cake. Further, 2,000 parts by mass of ion exchanged water was added to the toner cake, and washing was performed while a dehydration treatment was performed by pressurizing the toner cake to 0.3 MPa again. Further, after air drying was performed while maintaining 0.2 MPa, the toner cake was taken out and subjected to a deagglomeration treatment.

The toner cake subjected to the deagglomeration treatment was dried in a vacuum dryer at 40° C. for 12 hours, and then subjected to a classification treatment to obtain toner particles 1. The production conditions and analysis results of the toner particles 1 are shown in Tables 5-1 and 5-2 and 6.

### Production of Toner Particles 2 to 54 and Comparative Toner Particles 1 to 10

Toner particles 2 to 54 and comparative toner particles 1 to 10 were obtained in the same manner as in the production of the toner particles 1 except that the conditions were changed to those shown in Tables 5-1 and 5-2. The production conditions and analysis results of the toner particles 2 to 54 and the comparative toner particles 1 to 10 are shown in Tables 5-1 and 5-2 and 6.

TABLE 5-1

| | Core formation | | | | | | Shell formation | | | | |
|---|---|---|---|---|---|---|---|---|---|---|---|
| | | | | | | | | | Compound A | | 2% borax |
| | | | Ester wax having | | | | | | | 3% aqueous | aqueous |
| Toner | | | molecular weight | | Other waxes and | | Polyester | | | solution | solution |
| particle | Polyester resin | | of 650 or more | | the like | | resin | | | Parts by | Parts by |
| No. | No. | Parts | No. | Parts | Kind | Parts | No. | Parts | No. | mass | mass |
| 1 | 1 | 750 | 1 | 120 | — | 0 | 1 | 250 | A1 | 100 | 50 |
| 2 | 1 | 750 | 1 | 50 | Ester wax | 70 | 1 | 250 | A1 | 100 | 50 |
| | | | | | 11 | | | | | | |
| 3 | 2 | 750 | 2 | 120 | — | 0 | 2 | 250 | A2 | 100 | 50 |
| 4 | 1 | 750 | 1 | 120 | — | 0 | 1 | 250 | A1 | 100 | 280 |
| 5 | 1 | 750 | 1 | 120 | — | 0 | 1 | 250 | A1 | 100 | 900 |
| 6 | 1 | 750 | 1 | 120 | — | 0 | 1 | 250 | A1 | 100 | 10 |
| 7 | 1 | 750 | 1 | 120 | — | 0 | 1 | 250 | A1 | 100 | 0 |
| 8 | 3 | 750 | 1 | 120 | — | 0 | 3 | 250 | A1 | 100 | 50 |
| 9 | 4 | 750 | 1 | 120 | — | 0 | 4 | 250 | A1 | 100 | 50 |
| 10 | 5 | 750 | 1 | 120 | — | 0 | 5 | 250 | A1 | 100 | 50 |
| 11 | 6 | 750 | 1 | 120 | — | 0 | 6 | 250 | A1 | 100 | 50 |
| 12 | 7 | 750 | 1 | 120 | — | 0 | 7 | 250 | A1 | 100 | 50 |
| 13 | 1 | 750 | 1 | 120 | — | 0 | 1 | 250 | A3 | 100 | 50 |
| 14 | 1 | 750 | 1 | 120 | — | 0 | 1 | 250 | A4 | 100 | 50 |
| 15 | 1 | 750 | 1 | 120 | — | 0 | 1 | 250 | A5 | 100 | 50 |
| 16 | 1 | 750 | 1 | 120 | — | 0 | 1 | 250 | A7 | 100 | 50 |
| 17 | 1 | 750 | 1 | 120 | — | 0 | 1 | 250 | A6 | 100 | 50 |
| 18 | 1 | 750 | 1 | 120 | — | 0 | 1 | 250 | A1 | 10 | 50 |
| 19 | 1 | 750 | 1 | 120 | — | 0 | 1 | 250 | A1 | 7 | 50 |
| 20 | 1 | 750 | 1 | 120 | — | 0 | 1 | 250 | A1 | 4 | 50 |
| 21 | 1 | 750 | 1 | 120 | — | 0 | 1 | 250 | — | — | 50 |
| 22 | 1 | 750 | 1 | 120 | — | 0 | 1 | 250 | A1 | 800 | 50 |
| 23 | 1 | 750 | 1 | 120 | — | 0 | 1 | 250 | A1 | 1500 | 50 |
| 24 | 1 | 750 | 1 | 200 | — | 0 | 1 | 250 | A1 | 100 | 50 |
| 25 | 1 | 750 | 1 | 250 | — | 0 | 1 | 250 | A1 | 100 | 50 |
| 26 | 1 | 750 | 1 | 50 | — | 0 | 1 | 250 | A1 | 100 | 50 |
| 27 | 1 | 750 | 1 | 40 | — | 0 | 1 | 250 | A1 | 100 | 50 |
| 28 | 1 | 750 | 3 | 120 | — | 0 | 1 | 250 | A1 | 100 | 50 |
| 29 | 1 | 750 | 4 | 120 | — | 0 | 1 | 250 | A1 | 100 | 50 |
| 30 | 1 | 750 | 5 | 120 | — | 0 | 1 | 250 | A1 | 100 | 50 |
| 31 | 1 | 750 | 6 | 120 | — | 0 | 1 | 250 | A1 | 100 | 50 |
| 32 | 8 | 750 | 1 | 27 | Ester wax | 70 | 8 | 250 | A1 | 100 | 50 |
| | | | | | 11 | | | | | | |
| 33 | 8 | 750 | 1 | 20 | Ester wax | 70 | 8 | 250 | A1 | 100 | 50 |
| | | | | | 11 | | | | | | |

TABLE 5-2

| | Core formation | | | | | | Shell formation | | | | |
|---|---|---|---|---|---|---|---|---|---|---|---|
| | | | | | | | | | Compound A | | 2% borax |
| | | | Ester wax having | | | | | | | 3% aqueous | aqueous |
| Toner | | | molecular weight | | Other waxes and | | Polyester | | | solution | solution |
| particle | Polyester resin | | of 650 or more | | the like | | resin | | | Parts by | Parts by |
| No. | No. | Parts | No. | Parts | Kind | Parts | No. | Parts | No. | mass | mass |
| 34 | 1 | 750 | 1 | 200 | — | 0 | 1 | 250 | A1 | 100 | 50 |
| 35 | 1 | 750 | 1 | 250 | — | 0 | 1 | 250 | A1 | 100 | 50 |
| 36 | 1 | 750 | 7 | 120 | — | 0 | 1 | 250 | A1 | 100 | 50 |
| 37 | 1 | 750 | 8 | 120 | — | 0 | 1 | 250 | A1 | 100 | 50 |
| 38 | 1 | 750 | 9 | 120 | — | 0 | 1 | 250 | A1 | 100 | 50 |
| 39 | 1 | 750 | 10 | 120 | — | 0 | 1 | 250 | A1 | 100 | 50 |
| 40 | 8 | 750 | 1 | 100 | — | 0 | 8 | 250 | A1 | 100 | 50 |
| 41 | 9 | 750 | 1 | 100 | — | 0 | 9 | 250 | A1 | 100 | 50 |
| 42 | 10 | 750 | 1 | 120 | — | 0 | 10 | 250 | A1 | 100 | 50 |
| 43 | 11 | 750 | 1 | 120 | — | 0 | 11 | 250 | A1 | 100 | 50 |
| 44 | 1 | 750 | 1 | 120 | — | 0 | 1 | 250 | A1 | 100 | 50 |
| 45 | 1 | 750 | 1 | 120 | — | 0 | 1 | 250 | A1 | 100 | 50 |
| 46 | 1 | 750 | 1 | 120 | — | 0 | 1 | 250 | A1 | 100 | 50 |
| 47 | 1 | 750 | 1 | 120 | — | 0 | 1 | 250 | A1 | 100 | 50 |
| 48 | 1 | 750 | 1 | 120 | — | 0 | 1 | 250 | A1 | 100 | 50 |
| 49 | 1 | 750 | 1 | 120 | — | 0 | 1 | 250 | A1 | 100 | 50 |
| 50 | 1 | 750 | 1 | 40 | — | 0 | 1 | 250 | A1 | 100 | 50 |
| 51 | 1 | 750 | 1 | 30 | — | 0 | 1 | 250 | A1 | 100 | 50 |
| 52 | 12 | 750 | 1 | 140 | — | 0 | 12 | 250 | A1 | 100 | 50 |
| 53 | 13 | 750 | 1 | 160 | — | 0 | 13 | 250 | A1 | 100 | 50 |
| 54 | 14 | 750 | 1 | 120 | — | 0 | 14 | 250 | A1 | 100 | 50 |
| C. 1 | 1 | 750 | 1 | 120 | — | 0 | 1 | 250 | A1 | 100 | 50 |
| C. 2 | 1 | 750 | 1 | 120 | — | 0 | 1 | 250 | A1 | 100 | 50 |
| C. 3 | 1 | 750 | 1 | 120 | — | 0 | 1 | 250 | A1 | 100 | 50 |
| C. 4 | 1 | 750 | 1 | 25 | — | 0 | 1 | 250 | A1 | 100 | 50 |
| 0. 5 | 13 | 750 | 1 | 180 | — | 0 | 13 | 250 | A1 | 100 | 50 |
| C. 6 | 14 | 750 | — | 0 | Ester wax | 120 | 14 | 250 | A1 | 100 | 50 |
| | | | | | 11 | | | | | | |
| | | | | | Hydrocarb | 50 | | | | | |
| | | | | | on wax 1 | | | | | | |
| C. 7 | 14 | 750 | — | 0 | Hydrocarb | 50 | 14 | 250 | A1 | 100 | 0 |
| | | | | | on wax 1 | | | | | | |
| C. 8 | 15 | 750 | 1 | 120 | — | 0 | 15 | 250 | A1 | 100 | 50 |
| C. 9 | Styrene acrylic | 750 | 1 | 120 | — | 0 | — | — | A1 | 100 | 0 |
| | resin 1 | | | | | | | | | | |
| C. 10 | Styrene acrylic | 750 | 1 | 120 | CPES1 | 80 | — | — | A1 | 100 | 0 |
| | resin 1 | | | | | | | | | | |

In the Tables 5-1 and 5-2, “C.” indicates “Comparison”, the number of parts of each of the polyester resin, the wax, the other waxes, and the polyester resin represents the number of parts of 20 mass % of the dispersion. CPES1 represents the crystalline polyester resin 1.

TABLE 6-1

| Toner | Toner particle | | | | | | |
|---|---|---|---|---|---|---|---|
| particle | D4 | Content | IPA | | Content | Amount | B |
| No. | μm | X | amount | Kind of ester wax | Y | A | content |
| 1 | 6.7 | 9.4 | 13.4 | Dipentaerythritol hexastearate | 10.5 | 120 | 5.3 |
| 2 | 6.7 | 9.4 | 13.4 | Dipentaerythritol hexastearate | 4.4 | 120 | 5.3 |
| 3 | 6.7 | 6.8 | 7.1 | Pentaerythritol tetrabehenate | 10.5 | 120 | 5.3 |
| 4 | 6.7 | 9.2 | 13.4 | Dipentaerythritol hexastearate | 10.3 | 120 | 29.7 |
| 5 | 6.7 | 8.8 | 13.4 | Dipentaerythritol hexastearate | 9.8 | 120 | 95.4 |
| 6 | 6.7 | 9.5 | 13.4 | Dipentaerythritol hexastearate | 10.6 | 120 | 1.1 |
| 7 | 6.7 | 9.5 | 13.4 | Dipentaerythritol hexastearate | 10.6 | 120 | 0 |
| 8 | 6.7 | 9.4 | 5.4 | Dipentaerythritol hexastearate | 10.5 | 120 | 5.3 |
| 9 | 6.7 | 9.4 | 2.7 | Dipentaerythritol hexastearate | 10.5 | 120 | 5.3 |
| 10 | 6.7 | 9.4 | 22.1 | Dipentaerythritol hexastearate | 10.5 | 120 | 5.3 |
| 11 | 6.7 | 7.3 | 28.7 | Dipentaerythritol hexastearate | 10.5 | 120 | 5.3 |
| 12 | 6.7 | 5.5 | 31.4 | Dipentaerythritol hexastearate | 10.5 | 120 | 5.3 |
| 13 | 6.7 | 9.4 | 13.4 | Dipentaerythritol hexastearate | 10.5 | 120 | 5.3 |
| 14 | 6.7 | 9.4 | 13.4 | Dipentaerythritol hexastearate | 10.5 | 120 | 5.3 |
| 15 | 6.7 | 9.4 | 13.4 | Dipentaerythritol hexastearate | 10.5 | 120 | 5.3 |
| 16 | 6.7 | 9.4 | 13.4 | Dipentaerythritol hexastearate | 10.5 | 120 | 5.3 |
| 17 | 6.7 | 9.4 | 13.4 | Dipentaerythritol hexastearate | 10.5 | 120 | 5.3 |
| 18 | 6.7 | 9.5 | 13.4 | Dipentaerythritol hexastearate | 10.7 | 12 | 5.3 |
| 19 | 6.7 | 9.5 | 13.4 | Dipentaerythritol hexastearate | 10.7 | 8.4 | 5.3 |
| 20 | 6.7 | 9.5 | 13.4 | Dipentaerythritol hexastearate | 10.7 | 4.8 | 5.3 |
| 21 | 6.7 | 9.5 | 13.4 | Dipentaerythritol hexastearate | 10.7 | 0 | 5.3 |
| 22 | 6.7 | 8.6 | 13.4 | Dipentaerythritol hexastearate | 9.6 | 960 | 5.3 |
| 23 | 6.7 | 8.0 | 13.4 | Dipentaerythritol hexastearate | 8.9 | 1800 | 5.3 |
| 24 | 6.7 | 8.8 | 13.4 | Dipentaerythritol hexastearate | 16.4 | 120 | 5.3 |
| 25 | 6.7 | 8.5 | 13.4 | Dipentaerythritol hexastearate | 19.7 | 120 | 5.3 |
| 26 | 6.7 | 10.0 | 13.4 | Dipentaerythritol hexastearate | 4.7 | 120 | 5.3 |
| 27 | 6.7 | 10.1 | 13.4 | Dipentaerythritol hexastearate | 3.8 | 120 | 5.3 |
| 28 | 6.7 | 9.4 | 13.4 | Dibehenyl sebacate | 10.5 | 120 | 5.3 |
| 29 | 6.7 | 9.4 | 13.4 | 1,6-Hexanediol distearate | 10.5 | 120 | 5.3 |
| 30 | 6.7 | 9.4 | 13.4 | Pentaerythritol tetrapalmitate | 10.5 | 120 | 5.3 |
| 31 | 6.7 | 9.4 | 13.4 | Dipentaerythritol hexabehenate | 10.5 | 120 | 5.3 |
| 32 | 6.7 | 9.6 | 13.4 | Dipentaerythritol hexastearate | 2.4 | 120 | 5.3 |
| 33 | 6.7 | 9.7 | 13.4 | Dipentaerythritol hexastearate | 1.4 | 120 | 5.3 |

TABLE 6-2

| Toner | Toner particle | | | | | | |
|---|---|---|---|---|---|---|---|
| particle | D4 | Content | IPA | | Content | Amount | B |
| No. | μm | X | amount | Kind of ester wax | Y | A | content |
| 34 | 6.7 | 8.8 | 13.4 | Dipentaerythritol hexastearate | 16.4 | 120 | 5.3 |
| 35 | 6.7 | 8.5 | 13.4 | Dipentaerythritol hexastearate | 19.7 | 120 | 5.3 |
| 36 | 6.7 | 9.4 | 13.4 | 1,10-Decanediol ditriacontanate | 10.5 | 120 | 5.3 |
| 37 | 6.7 | 9.4 | 13.4 | Carnauba wax (main component: | 10.5 | 120 | 5.3 |
| | | | | myricyl montanate) | | | |
| 38 | 6.7 | 9.4 | 13.4 | Dipentaerythritol hexapalmitate | 10.5 | 120 | 5.3 |
| 39 | 6.7 | 9.4 | 13.4 | Distearyl terephthalate | 10.5 | 120 | 5.3 |
| 40 | 6.7 | 2.7 | 13.4 | Dipentaerythritol hexastearate | 8.9 | 120 | 5.3 |
| 41 | 6.7 | 2.4 | 13.4 | Dipentaerythritol hexastearate | 8.9 | 120 | 5.3 |
| 42 | 6.7 | 16.7 | 11.4 | Dipentaerythritol hexastearate | 10.5 | 120 | 5.3 |
| 43 | 6.7 | 20.3 | 9.8 | Dipentaerythritol hexastearate | 10.5 | 120 | 5.3 |
| 44 | 6.7 | 9.4 | 13.4 | Dipentaerythritol hexastearate | 10.5 | 120 | 5.3 |
| 45 | 6.7 | 9.4 | 13.4 | Dipentaerythritol hexastearate | 10.5 | 120 | 5.3 |
| 46 | 6.7 | 9.4 | 13.4 | Dipentaerythritol hexastearate | 10.5 | 120 | 5.3 |
| 47 | 6.7 | 9.4 | 13.4 | Dipentaerythritol hexastearate | 10.5 | 120 | 5.3 |
| 48 | 6.7 | 9.4 | 13.4 | Dipentaerythritol hexastearate | 10.5 | 120 | 5.3 |
| 49 | 6.7 | 9.4 | 13.4 | Dipentaerythritol hexastearate | 10.5 | 120 | 5.3 |
| 50 | 6.7 | 10.1 | 13.4 | Dipentaerythritol hexastearate | 3.8 | 120 | 5.3 |
| 51 | 6.7 | 10.2 | 13.4 | Dipentaerythritol hexastearate | 2.9 | 120 | 5.3 |
| 52 | 6.7 | 4.0 | 13.4 | Dipentaerythritol hexastearate | 12.1 | 120 | 5.3 |
| 53 | 6.7 | 3.4 | 13.4 | Dipentaerythritol hexastearate | 13.6 | 120 | 5.3 |
| 54 | 6.7 | 13.5 | 0.0 | Dipentaerythritol hexastearate | 10.5 | 120 | 5.3 |
| C. 1 | 6.7 | 9.4 | 13.4 | Dipentaerythritol hexastearate | 10.5 | 120 | 5.3 |
| C. 2 | 6.7 | 9.4 | 13.4 | Dipentaerythritol hexastearate | 10.5 | 120 | 5.3 |
| C. 3 | 6.7 | 9.4 | 13.4 | Dipentaerythritol hexastearate | 10.5 | 120 | 5.3 |
| C. 4 | 6.7 | 10.3 | 13.4 | Dipentaerythritol hexastearate | 2.4 | 120 | 5.3 |
| C. 5 | 6.7 | 3.4 | 13.4 | Dipentaerythritol hexastearate | 15.0 | 120 | 5.3 |
| C. 6 | 6.7 | 12.9 | 0.0 | Behenyl behenate | 0.0 | 120 | 5.3 |
| C. 7 | 6.7 | 14.4 | 0.0 | — | 0.0 | 120 | 0 |
| C. 8 | 6.7 | 0.0 | 13.4 | Dipentaerythritol hexastearate | 10.5 | 120 | 5.3 |
| C. 9 | 6.7 | 0.0 | 0.0 | Dipentaerythritol hexastearate | 13.8 | 0 | 0 |
| C. 10 | 6.7 | 0.0 | 0.0 | Dipentaerythritol hexastearate | 13.8 | 0 | 0 |

In Tables 6-1 and 6-2, “C.” indicates “Comparison”, the content X is a content (mass %) on a mass basis of the dodecenylsuccinic acid unit based on the mass of the toner particles, and the content Y is a content (mass %) on a mass basis of the ester wax based on the mass of the toner particles. “IPA amount” is the content (mass %) of the isophthalic acid unit in the polyester resin.

The “Amount A” is an extraction amount (ppm by mass) of the compound A extracted with ethanol from the toner based on the mass of the toner. The “B content” represents the content (ppm by mass) of the boron atom based on the mass of the toner particles.

### Production Example of Needle-Shaped Inorganic Particles 1

A 50%-NaOH aqueous solution was added to the metatitanic acid obtained by the sulfuric acid method as NaOH in a molar amount of 4 times that of TiO₂, and the mixture was heated at 95° C. for 2 hours. The mixture was thoroughly washed, 31%-HCl was added so that HCl/TiO₂ was 0.26, and then, heating was performed at a boiling point for 1 hour. After cooling, the mixture was neutralized to a pH of 7 with 1 mol/L-NaOH, and then washed and dried to produce fine particle rutile type titanium oxide. A specific surface area of the obtained fine particle rutile type titanium oxide was 115 g/m².

To 100 parts of the fine particle rutile type titanium oxide, 100 parts of NaCl and 25 parts of Na₂P₂O₇·10H₂O were added, mixing was performed with a vibration ball mill for 1 hour, and the mixture was fired at 850° C. for 2 hours in an electric furnace. The obtained fired product was put into pure water, heated at 80° C. for 6 hours, and then washed to remove a soluble salt. As the particles obtained by drying, needle-shaped inorganic particles 1 having a number-average value of minor diameters of 20 nm, a number-average value of major diameters of 600 nm, and an aspect ratio of 30 were obtained. The physical properties of the obtained needle-shaped inorganic particles 1 are shown in Table 7.

### Production Examples of Needle-Shaped Inorganic Particles 2 to 6 and Non-Needle-Shaped Inorganic Particles 1

Needle-shaped inorganic particles 2 to 6 and non-needle-shaped inorganic particles 1 were obtained in the same manner as in the production of the needle-shaped inorganic particles 1 except that the conditions were changed so as to achieve the physical properties shown in Table 7. The physical properties of the obtained needle-shaped inorganic particles 2 to 6 and the non-needle-shaped inorganic particles 1 are shown in Table 7.

TABLE 7

| | | Minor | Major | Aspect |
|---|---|---|---|---|
| | | diameter | diameter | ratio |
| Needle-shaped inorganic | Titanium | 20 | 600 | 30 |
| particle 1 | oxide | | | |
| Needle-shaped inorganic | Titanium | 10 | 300 | 30 |
| particle 2 | oxide | | | |
| Needle-shaped inorganic | Titanium | 70 | 700 | 10 |
| particle 3 | oxide | | | |
| Needle-shaped inorganic | Titanium | 45 | 225 | 5 |
| particle 4 | oxide | | | |
| Needle-shaped inorganic | Titanium | 5 | 150 | 30 |
| particle 5 | oxide | | | |
| Needle-shaped inorganic | Titanium | 10 | 20 | 2 |
| particle 6 | oxide | | | |
| Non-needle-shaped | Titanium | 20 | 20 | 1 |
| inorganic particle 1 | oxide | | | |

In Table 7, the minor diameter and the major diameter represent the number-average values (nm), and the aspect ratio represents the number-average value.

### Production of Toner 1

100.0 parts of toner particles 1
0.50 parts of needle-shaped inorganic particles 1
2.0 parts of RX50 (manufactured by Nippon Aerosil Co., Ltd.)
1.5 parts of RX200 (manufactured by Nippon Aerosil Co., Ltd.)

The above materials were mixed at 3,000 rpm for 7.5 minutes using a Henschel mixer FM10C (manufactured by NIPPON COKE & ENGINEERING. CO., LTD.) to obtain a toner 1. Physical properties of the obtained toner 1 are shown in Table 8.

The obtained toner 1 was evaluated by a procedure described below.

### Production of Toners 2 to 54 and Comparative Toners 1 to 10

Toners 2 to 54 and comparative toners 1 to 10 were obtained in the same manner as in the production of the toner 1 except that the conditions were changed to those shown in Table 8. Physical properties of the obtained toners 2 to 54 and the comparative toners 1 to 10 are shown in Table 9.

TABLE 8

External additive

| | | | | |
|---|---|---|---|---|
| | Toner | Needle-shaped | | |
| Toner | particle | inorganic particle | RX50 | RX200 |

| No. | No. | No. | parts | parts | parts |
|---|---|---|---|---|---|
| 1 | 1 | 1 | 0.50 | 2.0 | 1.5 |
| 2 | 2 | 1 | 0.50 | 2.0 | 1.5 |
| 3 | 3 | 1 | 0.50 | 2.0 | 1.5 |
| 4 | 4 | 1 | 0.50 | 2.0 | 1.5 |
| 5 | 5 | 1 | 0.50 | 2.0 | 1.5 |
| 6 | 6 | 1 | 0.50 | 2.0 | 1.5 |
| 7 | 7 | 1 | 0.50 | 2.0 | 1.5 |
| 8 | 8 | 1 | 0.50 | 2.0 | 1.5 |
| 9 | 9 | 1 | 0.50 | 2.0 | 1.5 |
| 10 | 10 | 1 | 0.50 | 2.0 | 1.5 |
| 11 | 11 | 1 | 0.50 | 2.0 | 1.5 |
| 12 | 12 | 1 | 0.50 | 2.0 | 1.5 |
| 13 | 13 | 1 | 0.50 | 2.0 | 1.5 |
| 14 | 14 | 1 | 0.50 | 2.0 | 1.5 |
| 15 | 15 | 1 | 0.50 | 2.0 | 1.5 |
| 16 | 16 | 1 | 0.50 | 2.0 | 1.5 |
| 17 | 17 | 1 | 0.50 | 2.0 | 1.5 |
| 18 | 18 | 1 | 0.50 | 2.0 | 1.5 |
| 19 | 19 | 1 | 0.50 | 2.0 | 1.5 |
| 20 | 20 | 1 | 0.50 | 2.0 | 1.5 |
| 21 | 21 | 1 | 0.50 | 2.0 | 1.5 |
| 22 | 22 | 1 | 0.50 | 2.0 | 1.5 |
| 23 | 23 | 1 | 0.50 | 2.0 | 1.5 |
| 24 | 24 | 1 | 0.30 | 2.0 | 1.5 |
| 25 | 25 | 1 | 0.20 | 2.0 | 1.5 |
| 26 | 26 | 1 | 0.80 | 2.0 | 1.5 |
| 27 | 27 | 1 | 0.90 | 2.0 | 1.5 |
| 28 | 28 | 1 | 0.50 | 2.0 | 1.5 |
| 29 | 29 | 1 | 0.50 | 2.0 | 1.5 |
| 30 | 30 | 1 | 0.50 | 2.0 | 1.5 |
| 31 | 31 | 1 | 0.50 | 2.0 | 1.5 |
| 32 | 32 | 1 | 0.50 | 2.0 | 1.5 |
| 33 | 33 | 1 | 0.50 | 2.0 | 1.5 |
| 34 | 34 | 1 | 0.60 | 2.0 | 1.5 |
| 35 | 35 | 1 | 0.60 | 2.0 | 1.5 |
| 36 | 36 | 1 | 0.50 | 2.0 | 1.5 |
| 37 | 37 | 1 | 0.50 | 2.0 | 1.5 |
| 38 | 38 | 1 | 0.50 | 2.0 | 1.5 |
| 39 | 39 | 1 | 0.50 | 2.0 | 1.5 |
| 40 | 40 | 1 | 0.50 | 2.0 | 1.5 |
| 41 | 41 | 1 | 0.50 | 2.0 | 1.5 |
| 42 | 42 | 1 | 0.50 | 2.0 | 1.5 |
| 43 | 43 | 1 | 0.50 | 2.0 | 1.5 |
| 44 | 44 | 1 | 0.10 | 2.0 | 1.5 |
| 45 | 45 | 1 | 0.05 | 2.0 | 1.5 |
| 46 | 46 | 1 | 1.80 | 2.0 | 1.5 |
| 47 | 47 | 2 | 0.50 | 2.0 | 1.5 |
| 48 | 48 | 3 | 0.50 | 2.0 | 1.5 |
| 49 | 49 | 4 | 0.50 | 2.0 | 1.5 |
| 50 | 50 | 1 | 0.50 | 2.0 | 1.5 |
| 51 | 51 | 1 | 0.50 | 2.0 | 1.5 |
| 52 | 52 | 1 | 0.50 | 2.0 | 1.5 |
| 53 | 53 | 1 | 0.50 | 2.0 | 1.5 |
| 54 | 54 | 1 | 0.50 | 2.0 | 1.5 |
| C. 1 | C. 1 | 5 | 0.50 | 2.0 | 1.5 |
| C. 2 | C. 2 | 6 | 0.50 | 2.0 | 1.5 |
| C. 3 | C. 3 | n1 | 0.50 | 2.0 | 1.5 |
| C. 4 | C. 4 | 1 | 0.50 | 2.0 | 1.5 |
| C. 5 | C. 5 | 1 | 0.50 | 2.0 | 1.5 |
| C. 6 | C. 6 | 1 | 0.50 | 2.0 | 1.5 |
| C. 7 | C. 7 | 1 | 0.50 | 2.0 | 1.5 |
| C. 8 | C. 8 | 1 | 0.50 | 2.0 | 1.5 |
| C. 9 | C. 9 | 1 | 0.50 | 2.0 | 1.5 |
| C. 10 | C. 10 | 1 | 0.50 | 2.0 | 1.5 |

In the Table 8, “C.” indicates “Comparison”, n1 indicates “Non-needle-shaped inorganic particle 1, “parts” indicates “Parts by mass”, and the amount of the needle-shaped inorganic particles represents the number of parts by mass with respect to 100 parts by mass of the toner particles.

TABLE 9

| | needle-shaped | | | | |
|---|---|---|---|---|---|
| | inorganic particle | | | | |
| Toner | | Minor | Aspect | | |
| No. | Content | diameter | ratio | Y/X | Z/Y |
| 1 | 0.50 | 20 | 30 | 1.118 | 0.046 |
| 2 | 0.50 | 20 | 30 | 0.466 | 0.110 |
| 3 | 0.50 | 20 | 30 | 1.550 | 0.046 |
| 4 | 0.50 | 20 | 30 | 1.118 | 0.047 |
| 5 | 0.50 | 20 | 30 | 1.118 | 0.049 |
| 6 | 0.50 | 20 | 30 | 1.118 | 0.046 |
| 7 | 0.50 | 20 | 30 | 1.118 | 0.045 |
| 8 | 0.50 | 20 | 30 | 1.118 | 0.046 |
| 9 | 0.50 | 20 | 30 | 1.118 | 0.046 |
| 10 | 0.50 | 20 | 30 | 1.118 | 0.046 |
| 11 | 0.50 | 20 | 30 | 1.449 | 0.046 |
| 12 | 0.50 | 20 | 30 | 1.908 | 0.046 |
| 13 | 0.50 | 20 | 30 | 1.118 | 0.046 |
| 14 | 0.50 | 20 | 30 | 1.118 | 0.046 |
| 15 | 0.50 | 20 | 30 | 1.118 | 0.046 |
| 16 | 0.50 | 20 | 30 | 1.118 | 0.046 |
| 17 | 0.50 | 20 | 30 | 1.118 | 0.046 |
| 18 | 0.50 | 20 | 30 | 1.118 | 0.045 |
| 19 | 0.50 | 20 | 30 | 1.118 | 0.045 |
| 20 | 0.50 | 20 | 30 | 1.118 | 0.045 |
| 21 | 0.50 | 20 | 30 | 1.118 | 0.045 |
| 22 | 0.50 | 20 | 30 | 1.118 | 0.050 |
| 23 | 0.50 | 20 | 30 | 1.118 | 0.054 |
| 24 | 0.30 | 20 | 30 | 1.863 | 0.023 |
| 25 | 0.20 | 20 | 30 | 2.328 | 0.010 |
| 26 | 0.80 | 20 | 30 | 0.466 | 0.164 |
| 27 | 0.90 | 20 | 30 | 0.373 | 0.228 |
| 28 | 0.50 | 20 | 30 | 1.118 | 0.046 |
| 29 | 0.50 | 20 | 30 | 1.118 | 0.046 |
| 30 | 0.50 | 20 | 30 | 1.118 | 0.046 |
| 31 | 0.50 | 20 | 30 | 1.118 | 0.046 |
| 32 | 0.50 | 20 | 30 | 0.894 | 0.199 |
| 33 | 0.50 | 20 | 30 | 0.662 | 0.267 |
| 34 | 0.50 | 20 | 30 | 1.863 | 0.035 |
| 35 | 0.50 | 20 | 30 | 2.328 | 0.029 |
| 36 | 0.50 | 20 | 30 | 1.118 | 0.046 |
| 37 | 0.50 | 20 | 30 | 1.118 | 0.046 |
| 38 | 0.50 | 20 | 30 | 1.118 | 0.046 |
| 39 | 0.50 | 20 | 30 | 1.118 | 0.046 |
| 40 | 0.50 | 20 | 30 | 3.311 | 0.054 |
| 41 | 0.50 | 20 | 30 | 3.725 | 0.054 |
| 42 | 0.50 | 20 | 30 | 0.632 | 0.046 |
| 43 | 0.50 | 20 | 30 | 0.518 | 0.046 |
| 44 | 0.10 | 20 | 30 | 1.118 | 0.009 |
| 45 | 0.05 | 20 | 30 | 1.118 | 0.005 |
| 46 | 1.80 | 20 | 30 | 1.118 | 0.162 |
| 47 | 0.50 | 10 | 30 | 1.118 | 0.046 |
| 48 | 0.50 | 70 | 10 | 1.118 | 0.046 |
| 49 | 0.50 | 45 | 5 | 1.118 | 0.046 |
| 50 | 0.50 | 20 | 30 | 0.373 | 0.127 |
| 51 | 0.50 | 20 | 30 | 0.279 | 0.168 |
| 52 | 0.50 | 20 | 30 | 2.980 | 0.040 |
| 53 | 0.50 | 20 | 30 | 3.973 | 0.035 |
| 54 | 0.50 | 20 | 30 | 0.780 | 0.046 |
| C. 1 | 0.50 | 5 | 30 | 1.118 | 0.046 |
| C. 2 | 0.50 | 10 | 2 | 1.118 | 0.046 |
| C. 3 | 0.50 | 20 | 1 | 1.118 | 0.046 |
| C. 4 | 0.50 | 20 | 30 | 0.233 | 0.201 |
| C. 5 | 0.50 | 20 | 30 | 4.470 | 0.032 |
| C. 6 | 0.50 | 20 | 30 | 0.000 | — |
| C. 7 | 0.50 | 20 | 30 | 0.000 | — |
| C. 8 | 0.50 | 20 | 30 | — | 0.046 |
| C. 9 | 0.50 | 20 | 30 | — | 0.035 |
| C. 10 | 0.50 | 20 | 30 | — | 0.035 |

In the table 9, “C.” indicates “Comparison”, and the content of the needle-shaped inorganic particles represents the number of parts by mass with respect to 100 parts by mass of the toner particles (note that the comparative toner 3 represents the amount of non-needle-shaped inorganic particles). The minor diameter of the needle-shaped inorganic particle represents a number-average value (nm), and the aspect ratio of the needle-shaped inorganic particle represents a number-average value.

### Example 1

For image evaluation, LBP-712Ci modified was used so that a process speed can be set to 400 mm/sec and a temperature of a fixing unit can be arbitrarily set. A process cartridge filled with 200 g of the toner 1 was allowed to stand at 25° C. and a humidity of 40% RH for 48 hours, and then an image for each evaluation was output. The amount of toner carried on transfer paper was 0.80 mg/cm².

### Evaluation of Low-Temperature Fixability

An image pattern in which 9 points of square images of 10 mm×10 mm were evenly arranged on the entire transfer paper was output. A fixing lower limit temperature and a fixing upper limit temperature were evaluated while changing a fixation temperature in a range of 120° C. to 240° C. at 5° C. intervals. Note that A4 paper (“Plover bond paper”: 105 g/m², manufactured by Fox River Paper Co.) was used as the transfer paper.

The fixed image was visually confirmed, and the lowest temperature at which cold offset did not occur was defined as the fixing lower limit temperature. The lower the fixing lower limit temperature, the more excellent the low-temperature fixability.

### Evaluation Criteria

A: The fixing lower limit temperature is 140° C. or lower.
B: The fixing lower limit temperature is from 145° C. to 155° C.
C: The fixing lower limit temperature is from 160° C. to 170° C.
D: The fixing lower limit temperature is 175° C. or higher.

### Releasability

In the evaluation of the low-temperature fixability, the maximum temperature at which hot offset did not occur was set as the fixing upper limit temperature, and the releasability was evaluated from a difference between the fixing lower limit temperature and the fixing upper limit temperature. The larger the difference between the fixing lower limit temperature and the fixing upper limit temperature, the more excellent the releasability.

### Evaluation Criteria

A: The difference between the fixing lower limit temperature and the fixing upper limit temperature is 35° C. or higher.
B: The difference between the fixing lower limit temperature and the fixing upper limit temperature is from 25° C. to 30° C.
C: The difference between the fixing lower limit temperature and the fixing upper limit temperature is from 15° C. to 20° C.
D: The difference between the fixing lower limit temperature and the fixing upper limit temperature is 10° C. or lower.

### Evaluation of Adhesion of Ejected Paper

The adhesion of ejected paper was evaluated by outputting a test chart having a printing ratio of 6% in a high-temperature and high-humidity environment (temperature: 32° C., 80% RH). The process speed was set to 400 mm/sec, and the set temperature of the fixing unit was set to a temperature higher than the lowest temperature by 10° C. at which cold offset did not occur in the toner to be evaluated. Note that, as the evaluation paper, “PB PAPER” (basis weight: 66 g/cm², letter, manufactured by Canon Marketing Japan Inc.) was used.

A continuous printing test of 1,000 sheets was performed. Thereafter, 1,000 sheets were stacked and left for 1 hour, and evaluation was performed based on the number of print defects when the 500th sheet was peeled off. The smaller the number of print defects, the better the adhesion of ejected paper suppression.

### Evaluation Criteria

A: The number of print defects is less than 5.
B: The number of printed defects is from 5 to 9.
C: The number of print defects is from 10 to 14.
D: The number of print defects is at least 15.

### Evaluation of Charge Rising Performance

The charge rising performance was evaluated by outputting 100 solid images in a high-temperature and high-humidity environment (temperature: 32° C., 80% RH). Note that A4 paper (“Plover bond paper”: 105 g/m², manufactured by Fox River Paper Co.) was used as the transfer paper. A density was measured using X-rite exact advance (manufactured by X-Rite, Incorporated). The smaller the difference in density between the first sheet and the 100th sheet, the better the charge rising performance.

### Evaluation Criteria

A: The difference between the average density values of the first sheet and the 100th sheet is not more than 0.03.
B: The difference between the average density values of the first sheet and the 100th sheet is from 0.04 to 0.06.
C: The difference between the average density values of the first sheet and the 100th sheet is from 0.07 to 0.09.
D: The difference between the average density values of the first sheet and the 100th sheet is at least 0.10.

### Examples 2 to 54 and Comparative Examples 1 to 10

Table 10 shows the evaluation results of Examples 2 to 54 and Comparative Examples 1 to 10 performed in the same manner as in Example 1.

TABLE 10-1

| Toner | Adhesion of | | Low-temperature | | | | Charge rising | |
|---|---|---|---|---|---|---|---|---|
| No. | ejected paper | | fixability | | Releasability | | performance | |
| 1 | A | 0 | A | 130 | A | 55 | A | 0.01 |
| 2 | A | 4 | A | 125 | A | 45 | A | 0.02 |
| 3 | A | 2 | A | 135 | A | 55 | A | 0.01 |
| 4 | A | 0 | A | 140 | A | 60 | A | 0.01 |
| 5 | A | 0 | B | 150 | A | 60 | A | 0.01 |
| 6 | A | 0 | A | 125 | A | 35 | A | 0.03 |
| 7 | A | 0 | A | 125 | B | 30 | B | 0.05 |
| 8 | B | 8 | A | 130 | A | 40 | A | 0.02 |
| 9 | C | 11 | A | 130 | A | 35 | A | 0.02 |
| 10 | A | 0 | A | 130 | A | 35 | A | 0.01 |
| 11 | A | 0 | A | 130 | B | 30 | A | 0.02 |
| 12 | A | 2 | A | 130 | C | 20 | A | 0.02 |
| 13 | A | 0 | A | 130 | A | 55 | A | 0.01 |
| 14 | A | 3 | A | 130 | A | 45 | A | 0.02 |
| 15 | A | 4 | A | 130 | A | 40 | A | 0.02 |
| 16 | B | 6 | A | 130 | A | 40 | A | 0.03 |
| 17 | B | 8 | A | 130 | A | 40 | B | 0.04 |
| 18 | A | 0 | A | 130 | A | 35 | A | 0.03 |
| 19 | A | 1 | A | 130 | B | 30 | B | 0.04 |
| 20 | A | 2 | B | 145 | B | 30 | B | 0.05 |
| 21 | A | 2 | B | 155 | B | 30 | C | 0.08 |
| 22 | A | 4 | A | 130 | B | 30 | B | 0.05 |
| 23 | B | 8 | A | 130 | B | 25 | C | 0.08 |
| 24 | B | 6 | A | 130 | A | 50 | A | 0.02 |
| 25 | C | 11 | A | 130 | A | 50 | B | 0.05 |
| 26 | A | 4 | B | 150 | A | 40 | A | 0.02 |
| 27 | B | 7 | C | 160 | B | 30 | A | 0.02 |
| 28 | B | 9 | A | 130 | B | 30 | A | 0.02 |
| 29 | C | 14 | A | 125 | B | 25 | A | 0.01 |
| 30 | A | 1 | A | 135 | A | 60 | A | 0.01 |
| 31 | A | 1 | A | 140 | A | 70 | A | 0.01 |
| 32 | A | 5 | A | 135 | B | 30 | A | 0.01 |
| 33 | B | 9 | A | 135 | C | 20 | A | 0.03 |

TABLE 10-2

| Toner | Adhesion of | | Low-temperature | | | | Charge rising | |
|---|---|---|---|---|---|---|---|---|
| No. | ejected paper | | fixability | | Releasability | | performance | |
| 34 | A | 4 | A | 130 | A | 60 | B | 0.04 |
| 35 | B | 7 | A | 130 | A | 65 | B | 0.06 |
| 36 | C | 12 | A | 130 | A | 45 | A | 0.01 |
| 37 | C | 14 | A | 130 | A | 35 | A | 0.01 |
| 38 | A | 0 | A | 130 | A | 60 | A | 0.01 |
| 39 | B | 7 | A | 130 | A | 45 | A | 0.02 |
| 40 | B | 8 | A | 140 | A | 55 | A | 0.02 |
| 41 | C | 10 | B | 150 | A | 55 | A | 0.03 |
| 42 | A | 2 | A | 125 | B | 25 | A | 0.02 |
| 43 | A | 3 | A | 125 | C | 20 | B | 0.04 |
| 44 | B | 8 | A | 130 | A | 55 | B | 0.04 |
| 45 | C | 11 | A | 130 | A | 45 | B | 0.05 |
| 46 | A | 3 | A | 130 | A | 55 | A | 0.04 |
| 47 | C | 12 | A | 130 | A | 55 | A | 0.02 |
| 48 | B | 9 | A | 130 | A | 55 | B | 0.06 |
| 49 | C | 10 | B | 145 | A | 55 | A | 0.03 |
| 50 | B | 7 | A | 155 | A | 45 | A | 0.02 |
| 51 | C | 12 | A | 125 | A | 35 | A | 0.03 |
| 52 | C | 6 | A | 125 | A | 55 | B | 0.05 |
| 53 | C | 13 | A | 125 | A | 60 | B | 0.06 |
| 54 | C | 13 | A | 130 | A | 35 | A | 0.02 |
| C. 1 | D | 16 | A | 130 | A | 55 | A | 0.03 |
| C. 2 | D | 24 | A | 130 | A | 55 | A | 0.03 |
| C. 3 | D | 18 | A | 130 | A | 55 | A | 0.01 |
| C. 4 | D | 16 | C | 160 | A | 40 | A | 0.03 |
| C. 5 | D | 21 | A | 135 | C | 20 | A | 0.02 |
| C. 6 | D | 23 | A | 130 | D | 10 | A | 0.02 |
| C. 7 | D | 26 | D | 180 | B | 30 | A | 0.03 |
| C. 8 | D | 22 | C | 170 | A | 50 | A | 0.01 |
| C. 9 | D | 23 | D | 195 | A | 55 | C | 0.07 |
| C. 10 | D | 30 | B | 145 | C | 15 | D | 0.10 |

In the table 10-2, “C.” indicates “Comparison”

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-060535, filed Apr. 4, 2024, and Japanese Patent Application No. 2025-028485, filed Feb. 26, 2025, which are hereby incorporated by reference herein in their entirety.

What is claimed is:

1. A toner comprising:
a toner particle comprising a binder resin and an ester wax; and
an external additive,
wherein the binder resin comprises a polyester resin comprising a dodecenylsuccinic acid unit,
a molecular weight of the ester wax is at least 650,
the external additive comprises a needle-shaped inorganic particle,
a number-average value of minor diameter of the needle-shaped inorganic particle is at least 10 nm,
a number-average value of aspect ratio of the needle-shaped inorganic particle is at least 5, and
X and Y satisfy the following Formula (1), where X (mass %) is a content of the dodecenylsuccinic acid unit based on a mass of the toner particle and Y (mass %) is a content of the ester wax based on the mass of the toner particle,
$$0.25 \leq Y / X \leq 4.0 0. \qquad ( 1 )$$

2. The toner according to claim 1, wherein the needle-shaped inorganic particle comprises a titanium oxide particle, and
a content of the titanium oxide particle in the toner is 0.10 to 2.00 parts by mass with respect to 100 parts by mass of the toner particle.

3. The toner according to claim 2, wherein when Z (mass %) is a content of the titanium oxide particle based on a mass of the toner, the Y and the Z satisfy the following Formula (3),
$$0.02 \leq Z / Y \leq 0.4 0. \qquad ( 3 )$$

4. The toner according to claim 1, wherein the X is 2.6 to 20.0 mass %.

5. The toner according to claim 1, wherein an SP value (cal/cm³)^{0.5} of the ester wax is 8.70 to 9.10.

6. The toner according to claim 1, wherein the Y is 2.0 to 20.0 mass %.

7. The toner according to claim 1, wherein the molecular weight of the ester wax is 800 to 3,000.

8. The toner according to claim 1, wherein the ester wax comprises a compound represented by the following Formula (2), 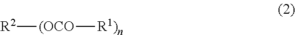
in Formula (2), R¹ represents an alkyl group having 17 to 22 carbon atoms, n represents the number of (OCO—R¹) bonded to R² and represents an integer of at least 1, and R² represents an n-valent hydrocarbon group having 2 to 6 carbon atoms, which may have —O— between C—C bonds.

9. The toner according to claim 1, wherein the ester wax comprises at least one selected from the group consisting of a condensate of pentaerythritol and an aliphatic carboxylic acid and a condensate of dipentaerythritol and an aliphatic carboxylic acid.

10. The toner according to claim 1, wherein the ester wax comprises at least one selected from the group consisting of a compound represented by the following Formula (6) and a compound represented by the following Formula (7), 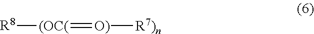
in Formula (6), R⁷ represents an alkyl group having 15 to 21 carbon atoms, n represents the number of (OC(═O)—R⁷) bonded to R⁸ and represents an integer of at least 2, and R⁸ represents an n-valent hydrocarbon group having 5 to 10 carbon atoms or an n-valent hydrocarbon group having 5 to 10 carbon atoms and having-O-between two carbon atoms, 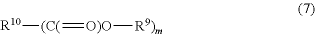
in Formula (7), R⁹ represents an alkyl group having 15 to 21 carbon atoms, m represents the number of (C(═O)O—R⁹) bonded to R¹⁰ and represents an integer of at least 2, and R¹⁰ represents an m-valent hydrocarbon group having 5 to 10 carbon atoms or an m-valent hydrocarbon group having 5 to 10 carbon atoms and having-O-between two carbon atoms.

11. The toner according to claim 10, wherein n in the Formula (6) is 4 to 6.

12. The toner according to claim 10, wherein m in the Formula (7) is 4 to 6.

13. The toner according to claim 1, wherein the toner particle further comprises a compound A that is at least one compound selected from the group consisting of a compound represented by the following Formula (4) and a compound represented by the following Formula (5), and
an extraction amount of the compound A extracted with ethanol from the toner based on a mass of the toner is 5 to 2000 ppm by mass, 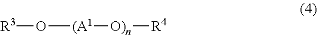
in Formula (4), R³ represents an alkyl group having 8 to 24 carbon atoms, A¹ represents an ethylene group or a propylene group, n is an integer of 5 to 60, and R⁴ is H, CH₂COOH, CH₂SO₃H, CH₂COONa, or CH₂SO₃Na, 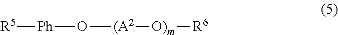
in Formula (5), R⁵ represents an alkyl group having 8 to 24 carbon atoms, Ph represents a phenylene group, A² represents an ethylene group or a propylene group, m is an integer of 5 to 60, and R⁶ is H, CH₂COOH, CH₂SO₃H, CH₂COONa, or CH₂SO₃Na.

14. The toner according to claim 1, wherein the polyester resin further comprises an isophthalic acid unit, and
a content of the isophthalic acid unit in the polyester resin is 5.0 to 30.0 mass % based on a mass of the polyester resin.

15. The toner according to claim 1, wherein the toner particle comprises a boron atom, and
a content of the boron atom based on the mass of the toner particle is 1.0 to 100.0 ppm by mass.

16. A cartridge attachable to and detachable from an image forming apparatus,
the cartridge comprising:
a toner; and
a toner container that contains the toner,
wherein the toner comprises
a toner particle comprising a binder resin and an ester wax and
an external additive,
the binder resin comprises a polyester resin comprising a dodecenylsuccinic acid unit,
a molecular weight of the ester wax is at least 650,
the external additive comprises a needle-shaped inorganic particle,
a number-average value of minor diameter of the needle-shaped inorganic particle is at least 10 nm,
a number-average value of aspect ratio of the needle-shaped inorganic particle is at least 5, and
X and Y satisfy the following Formula (1), where X (mass %) is a content of the dodecenylsuccinic acid unit based on a mass of the toner particle and Y (mass %) is a content of the ester wax based on the mass of the toner particle,
$$0.25 \leq Y / X \leq 4.0 0. \qquad ( 1 )$$

17. The cartridge according to claim 16, further comprising:
an electrostatic latent image bearing member;
a charging member that charges the electrostatic latent image bearing member; and
a toner carrying member that carries the toner and transports the toner to the electrostatic latent image bearing member.

18. An image forming apparatus comprising:
a toner;
an electrostatic latent image bearing member;
a charging member that charges the electrostatic latent image bearing member;
an exposing unit that forms an electrostatic latent image by exposing the charged electrostatic latent image bearing member; and
a developing unit that develops the electrostatic latent image formed on the electrostatic latent image bearing member using the toner carried on a toner carrying member,
wherein the toner comprises
a toner particle comprising a binder resin and an ester wax and
an external additive,
the binder resin comprises a polyester resin comprising a dodecenylsuccinic acid unit,
a molecular weight of the ester wax is at least 650,
the external additive comprises a needle-shaped inorganic particle,
a number-average value of minor diameter of the needle-shaped inorganic particle is at least 10 nm,
a number-average value of aspect ratio of the needle-shaped inorganic particle is at least 5, and
X and Y satisfy the following Formula (1), where X (mass %) is a content of the dodecenylsuccinic acid unit based on a mass of the toner particle and Y (mass %) is a content of the ester wax based on the mass of the toner particle,
$$0.25 \leq Y / X \leq 4.0 0. \qquad ( 1 )$$
